(19) United States
(12) Patent Application Publication
(10) Pub. No.: US 2013/0256593 A1
(43) Pub. Date: Oct. 3, 2013

(54) Color-Stable Superabsorbent

(71) Applicant: BASF SE, Ludwigshafen (DE)

(72) Inventors: Norbert Herfert, Altenstadt (DE); Thomas Daniel, Waldsee (DE); Klaus Dieter Hörner, Lampertheim (DE)

(73) Assignee: BASF SE, Ludwigshafen (DE)

(21) Appl. No.: 13/853,425

(22) Filed: Mar. 29, 2013

Related U.S. Application Data
(60) Provisional application No. 61/617,705, filed on Mar. 30, 2012.

(51) Int. Cl. B01J 20/26; B01J 20/30

(52) U.S. Cl. CPC B01J 20/267; B01J 20/3021
USPC 252/194; 502/402

(57) ABSTRACT

A superabsorbent obtainable by a process for producing superabsorbents by polymerizing a monomer solution comprising
a) at least one ethylenically unsaturated monomer which bears acid groups and is optionally present at least partly in salt form,
b) at least one crosslinker,
c) at least one initiator,
d) optionally one or more ethylenically unsaturated monomers copolymerizable with the monomers mentioned under a),
e) optionally one or more water-soluble polymers,
the process further comprising drying of the resulting polymer and optionally grinding of the dried polymer and sieving of the ground polymer and optionally surface postcrosslinking of the dried and optionally ground and sieved polymer, wherein at least one sulfonic acid derivative is added to the monomer mixture and/or to the polymer prior to the drying, and at least one phosphonic acid derivative is added to the polymer after the drying or optionally after the surface postcrosslinking, exhibits improved stability to discoloration in the course of storage at elevated temperatures or under elevated air humidity.

The present invention relates to a color-stable superabsorbent, to a process for producing it and to the use thereof and to hygiene articles comprising it. A color-stable superabsorbent is understood to mean a superabsorbent which is discolored only to a minor degree, if at all, in the course of storage at elevated temperature and under air humidity.

Superabsorbents are known. For such materials, names such as “highly swellable polymer”, “hydrogel” (often also used for the dry form), “hydrogel-forming polymer”, “water-absorbing polymer”, “absorbent gel-forming material”, “swellable resin”, “water-absorbing resin” or the like are also commonly used. These materials are crosslinked hydrophilic polymers, more particularly polymers formed from (co)polymerized hydrophilic monomers, graft (co)polymers of one or more hydrophilic monomers on a suitable graft base, crosslinked cellulose ethers or starch ethers, crosslinked carboxymethylcellulose, partly crosslinked polyalkylene oxide or natural products swellable in aqueous liquids, for example guar derivatives, the most common being water-absorbing polymers based on partly neutralized acrylic acid. The essential properties of superabsorbents are their abilities to absorb several times their own weight of aqueous liquids and not to release the liquid again, even under a certain pressure. The superabsorbent, which is used in the form of a dry powder, is converted to a gel when it absorbs liquid, and correspondingly to a hydrogel when it absorbs water as usual. Crosslinking is essential for synthetic superabsorbents and is an important difference from customary straightforward thickeners, since it leads to the insolubility of the polymers in water. Soluble substances would be unusable as superabsorbents. By far the most important field of use of superabsorbents is the absorption of body fluids. Superabsorbents are used, for example, in diapers for infants, incontinence products for adults or feminine hygiene products. Other fields of use are, for example, as water-retaining agents in market gardening, as water stores for protection from fire, for liquid absorption in food packaging, or quite generally for absorbing moisture.

Superabsorbents are capable of absorbing several times their own weight of water and of retaining it under a certain pressure. In general, such a superabsorbent has a CRC (“centrifuge retention capacity”, see below for test method) of at least 5 g/g, preferably at least 10 g/g and more preferably at least 15 g/g. A “superabsorbent” may also be a mixture of different individual superabsorbent substances or a mixture of components which exhibit superabsorbent properties only when they interact; it is not so much the substance composition as the superabsorbent properties that are important here.

What is important for a superabsorbent is not only its absorption capacity, but also the ability to retain fluid under pressure (retention, usually expressed as “Absorption under Load” (“AUL”) or “Absorption against Pressure” (“AAP”), for test method see below) and the permeability, i.e. the ability to conduct fluid in the swollen state (usually expressed as “Saline Flow Conductivity” (“SFC”), for test method see below). Swollen gel can hinder or prevent fluid conductivity to as yet unswollen superabsorbent (“gel blocking”). Good conductivity properties for fluids are possessed, for example, by hydrogels which have a high gel strength in the swollen state. Gels with only a low gel strength are deformable under an applied pressure (body pressure), block pores in the superabsorbent/cellulose fiber absorbent and thus prevent fluid conductivity to as yet unswollen or incompletely swollen superabsorbent and fluid absorption by this as yet unswollen or incompletely swollen superabsorbent. An increased gel strength is generally achieved through a higher degree of crosslinking, but this reduces the absorption capacity of the product. An elegant method of increasing the gel strength is that of increasing the degree of crosslinking at the surface of the superabsorbent particles compared to the interior of the particles. To this end, superabsorbent particles which have usually been dried in a surface postcrosslinking step and have an average crosslinking density are subjected to additional crosslinking in a thin surface layer of the particles thereof. The surface postcrosslinking increases the crosslinking density in the shell of the superabsorbent particles, which raises the absorption under compressive stress to a higher level. While the absorption capacity in the surface layer of the superabsorbent particles falls, their core, as a result of the presence of mobile polymer chains, has an improved absorption capacity compared to the shell, such that the shell structure ensures improved permeability, without occurrence of gel blocking. It is likewise known that superabsorbents which are relatively highly crosslinked overall can be obtained and the degree of crosslinking in the interior of the particles can subsequently be reduced compared to an outer shell of the particles.

Processes for producing superabsorbents are also known. Superabsorbents based on acrylic acid, which are the most common on the market, are produced by free-radical polymerization of acrylic acid in the presence of a crosslinker (the “inner crosslinker”), the acrylic acid being neutralized to a certain degree before, after or partly before and partly after the polymerization, typically by adding alkali, usually an aqueous sodium hydroxide solution. The polymer gel thus obtained is comminuted (according to the polymerization reactor used, this can be done simultaneously with the polymerization) and dried. The dry powder thus obtained (the “base polymer”) is typically postcrosslinked on the surface of the particles, by reacting it with further crosslinkers, for instance organic crosslinkers or polyvalent cations, for example aluminum (usually used in the form of aluminum sulfate) or both, in order to obtain a more highly crosslinked surface layer compared to the particle interior.

A problem which often occurs in the case of superabsorbents is discoloration, which occurs in the course of storage under elevated temperature or elevated air humidity. Such conditions often occur in the case of storage of superabsorbents in tropical or subtropical countries. Superabsorbents tend to yellow under such conditions; they may even assume a brown or even almost black color. This discoloration of the actually colorless superabsorbent powder is unsightly and undesired, since it is visible especially in the desired thin hygiene products, and consumers reject unsightly hygiene products. The cause of the discoloration has not been entirely clarified, but reactive compounds such as residual monomers from the polymerization, the use of some initiators, impurities in the monomer or the neutralizing agent, surface postcrosslinkers or stabilizers in the monomers used appear to be involved.

Fredric L. Buchholz and Andrew T. Graham (publishers) give, in: “Modern Superabsorbent Polymer Technology”, J. Wiley & Sons, New York, U.S.A./Wiley-VCH, Weinheim, Germany, 1997, ISBN 0-471-19411-5, a comprehensive review of superabsorbents, the properties thereof and processes for producing superabsorbents.

WO 00/55 245 A1 teaches the stabilization of superabsorbents against discoloration by treatment with an inorganic reducing agent and optionally a metal salt, for instance an alkaline earth metal salt, which is added after the polymerization. The inorganic reducing agent is typically a hypophosphite, phosphite, bisulfite or sulfite. The metal salt is typically a colorless (the property of “colorless” is often also simply referred to as “white”) phosphate, acetate or lactate, but not a halide. According to the teaching of WO 2006/058 682 A1, discoloration of superabsorbents is avoided when the drying and the postcrosslinking reaction are carried out in an atmosphere which is essentially free of oxidizing gases. WO 2009/060 062 A1 or WO 2010/012 762 A2 teach the addition of sulfinic acid derivatives to superabsorbents in order to stabilize them against discoloration. EP 1 199 315 A2 teaches the use of a redox initiator system for initiating a polymerization reaction, said redox initiator system comprising, as the reducing component, a sulfinic acid or a sulfinate, especially 2-hydroxysulfinatoacetic acid or a salt thereof. WO 99/18 067 A1 discloses particular hydroxyl- or aminoalkyl- or arylsulfinic acid derivatives or mixtures thereof and the use thereof as reducing agents which do not release formaldehyde. WO 2004/084 962 A1 relates to the use of these sulfinic acid derivatives as the reducing component of a redox initiator for polymerization of partly neutralized acrylic acid to superabsorbents.

Published specification JP 05/086 251 teaches the use of phosphoric acid derivatives or salts thereof, especially (1-hydroxyethane-1,1-diyl)bisphosphonic acid (also “1-hydroxyethylidene-1,1-diphosphonic acid”, “1-hydroxyethane-(1,1-diphosphonic acid)”, trivial name “etidronic acid”), ethylenediaminetetra(methylenephosphonic acid), diethylenetriaminepenta(methylenephosphonic acid) or the alkali metal or ammonium salts thereof as stabilizers of superabsorbents against discoloration. EP 781 804 A2 teaches, for the same purpose, the addition of (1-hydroxyalkyl-1,1-diyl)bisphosphonic acids, the alkyl radical comprising from 5 up to 23 carbon atoms.

EP 668 080 A2 teaches the addition of inorganic acids, organic acids or polyamino acids to superabsorbents, the inorganic acids specified also including phosphorus-based acids. US 2005/0 085 604 A1 discloses the addition of chelating agents and oxidizing or reducing agents to superabsorbents, the chelating agents also including those containing phosphorus. US 2005/0 272 600 A1 relates to the addition of ion blockers to superabsorbents, which also include organic phosphorus compounds. (1-Hydroxyethane-1,1-diyl)bisphosphonic acid is one of the examples mentioned. According to the teaching of EP 2 112 172 A1, an organic phosphorus compound is added to the monomer solution which is polymerized to give the superabsorbent; (1-hydroxyethane-1,1-diyl)bisphosphonic acid is mentioned; ethylenediaminetetra(methylenephosphonic acid) is the most preferred compound. US 2009/0 275 470 A1 teaches adding both chelating agents and preferably inorganic phosphorus compounds to superabsorbents, and the chelating agents may also be a phosphorus compound, for example (1-hydroxyethane-1,1-diyl)bisphosphonic acid or ethylenediaminetetra(methylenephosphonic acid). According to the teaching of WO 2006/109 882 A1 too, such compounds are added to superabsorbents as chelating agents, with use not only of phosphorus compounds but also of sulfur compounds in various process stages.

It is a constant objective to find other superabsorbents, or even superabsorbents which are stabilized better, against discoloration, especially against yellowing or browning in the course of storage under elevated temperature and/or elevated air humidity, and processes for production thereof. There should be no, or at least no significant, accompanying impairment of the service properties of the superabsorbent, especially its absorption capacity for fluid, including under pressure, and its ability to conduct fluid. Further objects of the invention are uses of this superabsorbent, such as hygiene products comprising this superabsorbent and processes for production thereof.

The object was achieved by a process for producing superabsorbents by polymerizing a monomer solution comprising

a) at least one ethylenically unsaturated monomer which bears acid groups and is optionally present at least partly in salt form,

b) at least one crosslinker,

c) at least one initiator,

d) optionally one or more ethylenically unsaturated monomers copolymerizable with the monomers mentioned under a),

e) optionally one or more water-soluble polymers,

the process further comprising drying of the resulting polymer and optionally grinding of the dried polymer and sieving of the ground polymer and optionally surface postcrosslinking of the dried and optionally ground and sieved polymer, wherein at least one sulfonic acid derivative is added to the monomer mixture and/or to the polymer prior to the drying, and at least one phosphonic acid derivative is added to the polymer after the drying or optionally after the surface postcrosslinking.

The inventive superabsorbents surprisingly exhibit good stability against discoloration, without any significant impairment in their service properties such as CRC, AUL or SFC.

According to the invention, at least one sulfonic acid derivative is added to the superabsorbent. Sulfonic acid derivatives in the context of this invention are compounds which derive from sulfonic acid with the general formula R—SO₂—OH and have the general formula (I):

R¹R²R³C—SO₂—OM (I)

in which

M is a hydrogen atom, an ammonium ion, a monovalent metal ion or one equivalent of a divalent metal ion of groups 1, 2, 8, 9, 10, 12 or 14 of the periodic table of the elements;

R¹ is OH or NR⁴R⁵ where R⁴ and R⁵ are each independently H or C₁-C₆-alkyl;

R² is H or an alkyl, alkenyl, cycloalkyl or aryl group, where this group optionally has 1, 2 or 3 substituents which are each independently selected from C₁-C₆-alkyl, OH, O—C₁-C₆-alkyl, halogen and CF₃; and

R³ is COOM, SO₃M, COR⁴, CONR⁴R⁵ or COOR⁴, where M, R⁴ and R⁵ are each as defined above or, when R² is aryl which is optionally substituted as specified above, is also H,

salts thereof and mixtures thereof and/or with salts thereof.

In the above formula (I), alkyl represents straight-chain or branched alkyl groups which have preferably 1-6 and especially 1-4 carbon atoms. Examples of alkyl groups are methyl, ethyl, n-propyl, isopropyl, n-butyl, t-butyl, n-hexyl, etc. The same applies to the alkyl groups in O-alkyl. Alkenyl represents straight-chain or branched alkenyl groups which have preferably 3-8 carbon atoms, especially 3-6 carbon atoms. A preferred alkenyl group is the allyl group. Cycloalkyl is especially C₁-C₆-cycloalkyl, particular preference being given to cyclopentyl and cyclohexyl. Aryl (including in aralkyl) is preferably phenyl or naphthyl. When the aryl radical is a phenyl group and is substituted, it preferably has two substituents. These are present especially in the 2 and/or 4 position.

Halogen is F, Cl, Br and I, preferably Cl and Br.

M is preferably an ammonium ion, alkali metal ion or one equivalent of an alkaline earth metal or zinc ion. Suitable alkali metal ions are especially sodium and potassium ions; suitable alkaline earth metal ions are in particular magnesium, strontium and calcium ions.

R¹ is preferably a hydroxyl or amino group.

R² is preferably a hydrogen atom or an alkyl or aryl group which may be substituted as above. It preferably has one or two hydroxyl and/or alkoxy substituents.

R³ is preferably either COOM or COOR⁴ (M and R⁴ are each defined as specified above) or, when R² is aryl which may be substituted as specified above, is also a hydrogen atom.

In a preferred embodiment, the superabsorbent comprises compounds of the above formula (I) in which M is an alkali metal ion or one equivalent of an alkaline earth metal or zinc ion; R¹ is a hydroxyl or amino group; R² is H or alkyl and R₃ is COOM or COOR⁴, where, when R³ is COOM, M in this COOM radical is H, an alkali metal ion or one equivalent of an alkaline earth metal ion, and, when R³ is COOR⁴, R⁴ is C₁-C₆-alkyl. Particularly preferred compounds of the above formula (I) are 2-hydroxy-2-sulfonatoacetic acid and salts thereof, especially the sodium salts thereof, and among these especially the disodium salt thereof.

In a further preferred embodiment, the superabsorbent comprises compounds of the above formula in which M is an alkali metal ion or one equivalent of an alkaline earth metal or zinc ion; R¹ is a hydroxyl or amino group; R² is aryl which is optionally substituted as specified above, especially hydroxyphenyl or C₁-C₄-alkoxyphenyl; and R³ is a hydrogen atom.

Groups 1 (H, Li, Na, K, Rb, Cs, Fr), 2 (Be, Mg, Ca, Sr, Ba, Ra), 8 (Fe, Ru, Os), 9 (Co, Rh, Ir), 10 (Ni, Pd, Pt), 12 (Zn, Cd, Hg) and 14 (C, Si, Ge, Sn, Pb) of the Periodic Table of the Elements in the current IUPAC numbering (International Union of Pure and Applied Chemistry, 104 T.W. Alexander Drive, Building 19, Research Triangle Park, N.C. 27709, U.S.A., www.iupac.org), the international organization responsible for nomenclature in the field of chemistry, correspond to groups Ia, IIa, IIIb, IVa and VIIIb in the numbering used by CAS (Chemical Abstracts Service, 2540 Olentangy River Road, Columbus, Ohio 43202, U.S.A., www.cas.org).

The sulfonic acid derivatives of the above formula can be used in pure form, but optionally also in a mixture with the sulfite of the corresponding metal ion and the corresponding sulfinic acid derivative.

The preparation of such mixtures is known and is described, for example, in WO 99/18 067 A1. They are also standard commercial products and are available, for example, in the form of mixtures of the sodium salt of 2-hydroxy-2-sulfinatoacetic acid, the disodium salt of 2-hydroxy-2-sulfonatoacetic acid and sodium bisulfite from L. Brüggemann KG (Salzstrasse 131, 74076 Heilbronn, Germany, www.brueggemann.com) under the BRÜGGOLIT® FF6M or BRÜGGOLIT® FF7 names, or alternatively BRUGGOLITE® FF6M or BRUGGOLITE® FF7.

Preference is given to the use of the sulfonic acid derivatives in pure form. The preparation of sulfonic acid derivatives is well-known; it is effected, for example, by sulfoxidation, sulfochlorination with subsequent hydrolysis or by sulfonation of appropriate starting compounds. They are also standard commercial products. For example, the disodium salt of 2-hydroxy-2-sulfonatoacetic acid is available from L. Brüggemann KG (Salzstrasse 131, 74076 Heilbronn, Germany, www.brueggemann.com) under the BLANCOLEN® HP name.

According to the invention, at least one phosphonic acid derivative is added to the superabsorbent. In the context of this invention, phosphonic acid itself should be understood as a phosphonic acid derivative. Phosphonic acid derivatives are compounds which derive from phosphonic acid with the general formula (HP(O)(OH)₂) and have the general formula (II):

R⁶—P(O)(OH)₂ (II)

where R⁶ is an optionally substituted organic radical. Salts and/or esters thereof and mixtures of such phosphonic acid derivatives, salts and/or esters are likewise usable.

Examples are monoalkylphosphonic acids and monoalkenylphosphonic acids, for instance laurylphosphonic acid and stearylphosphonic acid. Further examples are 1-hydroxyethylidene-1,1-diphosphonic acid, 2-phosphonobutane-1,2,4-tricarboxy acid, ethylenediamine-N,N′-di(methylenephosphonic acid), ethylenediaminetetra(methylenephosphonic acid), nitriloacetic acid-di(methylenephosphonic acid), nitrilodiacetic acid(methylenephosphonic acid), nitriloacetic acid-propionic acid-methylenephosphonic acid, nitrilotris(methylenephosphonic acid), cyclohexanediaminetetra(methylenephosphonic acid), ethylenediamine-N,N′-diacetic acid-N,N′-di(methylenephosphonic acid), tetramethylenediaminetetra(methylenephosphonic acid), hexamethylenediaminetetra(methylenephosphonic acid), polymethylenediaminetetra(methylenephosphonic acid), diethylenetriaminepenta(methylenephosphonic acid), hydroxyethylaminobis(methylenephosphonic acid), bishexamethylenetriaminepenta(methylenephosphonic acid), phytic acid, 2-hydroxy-2-phosphonatoacetic acid and the salts of these compounds.

Preferred phosphonic acid derivatives are those in which R⁶ is a diyl radical bearing two phosphonic acid radicals, especially a 1-amino-1,1-diyl radical or a 1-hydroxy-1,1-diyl radical, as in 1-hydroxyalkyl-1,1-diylbisphosphonic acid, where alkyl in these compounds is a C₁-C₂₅ radical, particular preference being given to ethyl. The most preferred phosphonic acid derivative is (1-hydroxyethane-1,1-diyl)bisphosphonic acid or a salt with a metal M (as defined above), especially a sodium salt or disodium salt. Further preferred phosphonic acid derivatives are those in which R⁶ is an amino-substituted alkyl radical, especially an amino-substituted methylene radical, as in ethylenediaminetetra(methylenephosphonic acid), diethylenetriaminepenta(methylenephosphonic acid) and [nitrilotris(methylene)]tris(phosphonic acid).

Such phosphonic acid derivatives are known and are prepared by a standard route, for example by Michaelis-Arbuzov reaction, quasi-Mannich reaction of the free phosphonic acid (tautomeric with phosphorous acid) with formaldehyde and oligoethyleneamines or by acylation of phosphonic acid with carboxylic anhydrides or nitriles. The main use thereof is that as phosphate substitutes in detergents. They are therefore also standard commercial products and are available, for example, under the Cublen® brand from Zschimmer & Schwarz Mohsdorf GmbH & Co KG, Chemnitztalstrasse 1, 09217 Burgstädt, Germany.

The process according to the invention for producing superabsorbents is a process for aqueous solution polymerization of a monomer mixture comprising the following:

a) at least one ethylenically unsaturated monomer which bears at least on acid group and is optionally present at least partly in salt form,

b) at least one crosslinker,

c) at least one initiator,

d) optionally one or more ethylenically unsaturated monomers copolymerizable with the monomers mentioned under a), and

e) optionally one or more water-soluble polymers.

The monomers a) are preferably water-soluble, i.e. the solubility in water at 23° C. is typically at least 1 g/100 g of water, preferably at least 5 g/100 g of water, more preferably at least 25 g/100 g of water and most preferably at least 35 g/100 g of water.

Suitable monomers a) are, for example, ethylenically unsaturated carboxylic acids or salts thereof, such as acrylic acid, methacrylic acid, maleic acid or salts thereof, maleic anhydride and itaconic acid or salts thereof. Particularly preferred monomers are acrylic acid and methacrylic acid. Very particular preference is given to acrylic acid.

Further suitable monomers a) are, for example, ethylenically unsaturated sulfonic acids, such as styrenesulfonic acid and 2-acrylamido-2-methylpropanesulfonic acid (AMPS).

Impurities can have a considerable influence on the polymerization. The raw materials used should therefore have a maximum purity. It is therefore often advantageous to specially purify the monomers a). Suitable purification processes are described, for example, in WO 2002/055469 A1, WO 2003/078378 A1 and WO 2004/035514 A1. A suitable monomer a) is, for example, acrylic acid purified according to WO 2004/035514 A1 and comprising 99.8460% by weight of acrylic acid, 0.0950% by weight of acetic acid, 0.0332% by weight of water, 0.0203% by weight of propionic acid, 0.0001% by weight of furfurals, 0.0001% by weight of maleic anhydride, 0.0003% by weight of diacrylic acid and 0.0050% by weight of hydroquinone monomethyl ether.

The proportion of acrylic acid and/or salts thereof in the total amount of monomers a) is preferably at least 50 mol %, more preferably at least 90 mol %, most preferably at least 95 mol %.

The monomer solution comprises preferably at most 250 ppm by weight, preferably at most 130 ppm by weight, more preferably at most 70 ppm by weight and preferably at least 10 ppm by weight, more preferably at least 30 ppm by weight, especially around 50 ppm by weight, of hydroquinone monoether, based in each case on the unneutralized monomer a); neutralized monomer a), i.e. a salt of the monomer a), is considered for arithmetic purposes to be unneutralized monomer. For example, the monomer solution can be prepared by using an ethylenically unsaturated monomer bearing acid groups with an appropriate content of hydroquinone monoether.

Preferred hydroquinone monoethers are hydroquinone monomethyl ether (MEHQ) and/or alpha-tocopherol (vitamin E).

Suitable crosslinkers b) are compounds having at least two groups suitable for crosslinking. Such groups are, for example, ethylenically unsaturated groups which can be polymerized free-radically into the polymer chain, and functional groups which can form covalent bonds with the acid groups of the monomer a). In addition, polyvalent metal salts which can form coordinate bonds with at least two acid groups of the monomer a) are also suitable as crosslinkers b).

Crosslinkers b) are preferably compounds having at least two polymerizable groups which can be polymerized free-radically into the polymer network. Suitable crosslinkers b) are, for example, ethylene glycol dimethacrylate, diethylene glycol diacrylate, polyethylene glycol diacrylate, allyl methacrylate, trimethylolpropane triacrylate, triallylamine, tetraallylammonium chloride, tetraallyloxyethane, as described in EP 530 438 A1, di- and triacrylates, as described in EP 547 847 A1, EP 559 476 A1, EP 632 068 A1, WO 93/21237 A1, WO 2003/104299 A1, WO 2003/104300 A1, WO 2003/104301A1 and DE 103 31 450 A1, mixed acrylates which, as well as acrylate groups, comprise further ethylenically unsaturated groups, as described in DE 103 31 456 A1 and DE 103 55 401A1, or crosslinker mixtures, as described, for example, in DE 195 43 368 A1, DE 196 46 484 A1, WO 90/15830 A1 and WO 2002/32962 A2.

Preferred crosslinkers b) are pentaerythrityl triallyl ether, tetraallyloxyethane, methylenebismethacrylamide, 15- to 20-tuply ethoxylated trimethylolpropane triacrylate, 15-20-tuply ethoxylated glyceryl triacrylate, polyethylene glycol diacrylate having between 4 and 45-CH₂CH₂O units in the molecule chain, trimethylolpropane triacrylate and triallylamine.

Very particularly preferred crosslinkers b) are the polyethoxylated and/or -propoxylated glycerols which have been esterified with acrylic acid or methacrylic acid to give di- or triacrylates, as described, for example, in WO 2003/104301A1. Di- and/or triacrylates of 3- to 10-tuply ethoxylated glycerol are particularly advantageous. Very particular preference is given to di- or triacrylates of 1- to 5-tuply ethoxylated and/or propoxylated glycerol. Most preferred are the triacrylates of 3- to 5-tuply ethoxylated and/or propoxylated glycerol, especially the triacrylate of 3-tuply ethoxylated glycerol.

The amount of crosslinker b) is preferably from 0.05 to 1.5% by weight, more preferably from 0.1 to 1% by weight, most preferably from 0.3 to 0.6% by weight, based in each case on monomer a). With rising crosslinker content, the centrifuge retention capacity (CRC) falls and the absorption under a pressure of 0.3 psi (AUL0.3 psi) rises.

The initiators c) used may be all compounds which generate free radicals under the polymerization conditions, for example thermal initiators, redox initiators and/or photoinitiators. Suitable redox initiators are sodium peroxodisulfate/ascorbic acid, hydrogen peroxide/ascorbic acid, sodium peroxodisulfate/sodium bisulfite and hydrogen peroxide/sodium bisulfite. Preference is given to using mixtures of thermal initiators and redox initiators, such as sodium peroxodisulfate/hydrogen peroxide/ascorbic acid. However, the reducing component used is preferably also the sulfonic acid derivative of the formula (I). The initiators are, incidentally, used in customary amounts. The customary amount of the reducing component of a redox initiator is generally at least 0.00001% by weight, preferably at least 0.0001% by weight and more preferably at least 0.001% by weight, and generally at most 0.2% by weight and preferably at most 0.1% by weight, based in each case on the amount of monomers a) and d). When, however, the sole reducing component used in the redox initiator is sulfonic acid derivative of the formula (I), the added amount thereof is generally at least 0.001% by weight, preferably at least 0.01% by weight and more preferably at least 0.03% by weight, and generally at most 1.0% by weight, preferably at most 0.3% by weight and more preferably at most 0.2% by weight, based in each case on the amount of monomers a) and d). The customary amount of the oxidizing component of a redox initiator is generally 0.0001% by weight and more preferably at least 0.001% by weight, and generally at most 2% by weight and preferably at most 1.0% by weight, based in each case on the amount of monomers a) and d). The customary amount of the thermal initiators is generally 0.01% by weight and more preferably at least 0.1% by weight, and generally at most 2% by weight and preferably at most 1.0% by weight, based in each case on the amount of monomers a) and d). The customary amount of the photoinitiators is generally 0.001% by weight and more preferably at least 0.01% by weight, and generally at most 1.0% by weight and preferably at most 0.2% by weight, based in each case on the amount of monomers a) and d).

Ethylenically unsaturated monomers d) copolymerizable with the ethylenically unsaturated monomers a) bearing acid groups are, for example, acrylamide, methacrylamide, hydroxyethyl acrylate, hydroxyethyl methacrylate, dimethylaminoethyl methacrylate, dimethylaminoethyl acrylate, dimethylaminopropyl acrylate, diethylaminopropyl acrylate, dimethylaminoethyl methacrylate, diethylaminoethyl methacrylate, maleic acid or salts thereof and maleic anhydride.

The water-soluble polymers e) used may be polyvinyl alcohol, polyvinylpyrrolidone, starch, starch derivatives, modified cellulose, such as methylcellulose or hydroxyethylcellulose, gelatin, polyglycols or polyacrylic acids, preferably starch, starch derivatives and modified cellulose.

Typically, an aqueous monomer solution is used. The water content of the monomer solution is preferably from 40 to 75% by weight, more preferably from 45 to 70% by weight and most preferably from 50 to 65% by weight. It is also possible to use monomer suspensions, i.e. oversaturated monomer solutions. With rising water content, the energy requirement in the subsequent drying rises, and, with falling water content, the heat of polymerization can only be removed inadequately.

For optimal action, the preferred polymerization inhibitors require dissolved oxygen. The monomer solution can therefore be freed of dissolved oxygen before the polymerization by inertization, i.e. flowing an inert gas through, preferably nitrogen or carbon dioxide. The oxygen content of the monomer solution is preferably lowered before the polymerization to less than 1 ppm by weight, more preferably to less than 0.5 ppm by weight, most preferably to less than 0.1 ppm by weight.

The monomer mixture may comprise further components. Examples of further components used in such monomer mixtures are, for instance, chelating agents in order to keep metal ions in solution, or inorganic powders in order to increase the stiffness of the superabsorbent in the swollen state, or recycled undersize from a later grinding operation. It is possible here to use all known additions to the monomer mixture. Even though only “solution” is discussed here in connection with the monomer mixture, this also means the polymerization of a suspension, for instance when insoluble constituents are added to the monomer mixture.

The acid groups of the polymer gels resulting from the polymerization have typically been partly neutralized. Neutralization is preferably carried out at the monomer stage; in other words, salts of the monomers bearing acid groups or, to be precise, a mixture of monomers bearing acid groups and salts of the monomers bearing acid groups (“partly neutralized acid”) are used as component a) in the polymerization. This is typically accomplished by mixing in the neutralizing agent as an aqueous solution or preferably also as a solid into the monomer mixture intended for polymerization or preferably into the monomer bearing acid groups or a solution thereof. The degree of neutralization is preferably from 25 to 95 mol %, more preferably from 50 to 80 mol % and most preferably from 65 to 72 mol %, for which the customary neutralizing agents can be used, preferably alkali metal hydroxides, alkali metal oxides, alkali metal carbonates or alkali metal hydrogencarbonates and also mixtures thereof. Instead of alkali metal salts, it is also possible to use ammonium salts. Particularly preferred alkali metals are sodium and potassium, but very particular preference is given to sodium hydroxide, sodium carbonate or sodium hydrogencarbonate and also mixtures thereof.

However, it is also possible to carry out the neutralization after the polymerization, at the stage of the polymer gel formed in the polymerization. It is also possible to neutralize up to 40 mol %, preferably 10 to 30 mol % and more preferably 15 to 25 mol % of the acid groups before the polymerization by adding a portion of the neutralizing agent directly to the monomer solution and setting the desired final degree of neutralization only after the polymerization, at the polymer gel stage. When the polymer gel is neutralized at least partly after the polymerization, the polymer gel is preferably comminuted mechanically, for example by means of an extruder, in which case the neutralizing agent can be sprayed, sprinkled or poured on and then carefully mixed in. To this end, the gel mass obtained can be repeatedly extruded for homogenization.

However, preference is given to performing the neutralization at the monomer stage. In other words: in a very particularly preferred embodiment, the monomer a) used is a mixture of 25 to 95 mol %, more preferably from 50 to 80 mol % and most preferably from 65 to 75 mol % of salt of the monomer bearing acid groups, and the remainder to 100 mol % of monomer bearing acid groups. This mixture is, for example, a mixture of sodium acrylate and acrylic acid or a mixture of potassium acrylate and acrylic acid.

In a preferred embodiment, the neutralizing agent used for the neutralization is one whose iron content is generally below 10 ppm by weight, preferably below 2 ppm by weight and more preferably below 1 ppm by weight. Likewise desired is a low content of chloride and anions of oxygen acids of chlorine. A suitable neutralizing agent is, for example, the 50% by weight sodium hydroxide solution or potassium hydroxide solution which is typically traded as “membrane grade”; even more pure and likewise suitable, but also more expensive, is the 50% by weight sodium hydroxide solution or potassium hydroxide solution typically traded as “amalgam grade” or “mercury process”.

Processes for production of superabsorbents from monomer mixtures, such as those described by way of example above, are known in principle. Suitable polymerization reactors are, for example, kneading reactors or belt reactors. In the kneader, the polymer gel formed in the polymerization of an aqueous monomer solution or suspension is comminuted continuously by, for example, contrarotatory stirrer shafts, as described in WO 2001/38402 A1. Polymerization on a belt is described, for example, in EP 955 086 A2, DE 38 25 366 A1 and U.S. Pat. No. 6,241,928. Polymerization in a belt reactor forms, like the likewise known polymerization in batchwise operation or in a tubular reactor, as described, for example, in EP 445 619 A2 and DE 19 846 413 A1, a polymer gel which has to be comminuted in a further process step, for example in a meat grinder, extruder or kneader. It is also possible to produce spherical or differently shaped superabsorbent particles by suspension or emulsion polymerization, as described, for example, in EP 457 660 A1, or by spray or droplet polymerization processes, as described, for example, in EP 348 180 A1, EP 816 383 A1, WO 96/404 27 A1, U.S. Pat. No. 4,020,256, US 2002/0 193 546 A1, DE 35 19 013 A1, DE 10 2005 044 035 A1, WO 2007/093531A1, WO 2008/086 976 A1 or WO 2009/027 356 A1 Likewise known are processes in which the monomer mixture is applied to a substrate, for example a nonwoven web, and polymerized, as described, for instance, in WO 02/94 328 A2 and WO 02/94 329 A1.

The sulfonic acid derivative of the formula (I) is added before the drying in the process according to the invention. The addition can be effected at any time before the drying; for example, sulfonic acid derivative can be added to the monomer solution prior to polymerization, added during the polymerization and added to the resulting polymer gel after the polymerization. In the case of addition to the monomer solution prior to polymerization, the homogeneous incorporation of the sulfonic acid derivative by mixing is the technically simplest method; preference is therefore given to the addition thereof to the monomer solution. Addition during the polymerization is possible in a simple manner especially when the polymerization is effected in a kneading reactor, since incorporation by mixing is then likewise possible without a separate process step. However, it is likewise possible to mix the sulfonic acid derivative into the swollen polymer gel. If the polymerization is performed in a kneading reactor, the addition can be effected into the kneading reactor toward the end of the polymerization (in the case of continuously conveying kneading reactors, correspondingly, closer to the outlet than to the inlet) or in a separate process step between polymerization and drying. In principle, a suitable apparatus for this purpose is any which can mix the sulfonic acid derivative into the gel with adequate homogeneity; particular options are kneaders, screw mixers and extruders.

When the drying coincides with the polymerization, as, for instance, in processes for dropletization polymerization, the sulfonic acid derivative is necessarily added to the monomer mixture.

The sulfonic acid derivative of the formula (I) is generally added in an amount of at least 0.001% by weight, preferably at least 0.01% by weight and more preferably at least 0.03% by weight, and generally at most 1.0% by weight, preferably at most 0.3% by weight and more preferably at most 0.2% by weight, based in each case on the amount of monomers a) and d).

The polymer gel obtained from the aqueous solution polymerization and optional subsequent neutralization is then preferably dried with a belt drier until the residual moisture content is preferably 0.5 to 15% by weight, more preferably 1 to 10% by weight and most preferably from 2 to 8% by weight (see below for test method for the residual moisture or water content). In the case of too high a residual moisture content, the dried polymer gel has too low a glass transition temperature Tg and can be processed further only with difficulty. In the case of too low a residual moisture content, the dried polymer gel is too brittle and, in the subsequent comminution steps, undesirably large amounts of polymer particles with an excessively low particle size are obtained (“fines”). The solids content of the gel before drying is generally from 25 to 90% by weight, preferably from 30 to 80% by weight, more preferably from 35 to 70% by weight and most preferably from 40 to 60% by weight. Optionally, however, it is also possible to dry using a fluidized bed drier or a heatable mixer with a mechanical mixing unit, for example a paddle drier or a similar drier with mixing tools of different design. Optionally, the drier can be operated under nitrogen or another nonoxidizing inert gas or at least under reduced partial oxygen pressure in order to prevent oxidative yellowing processes. In general, however, even sufficient venting and removal of water vapor leads to an acceptable product. In general, a minimum drying time is advantageous with regard to color and product quality.

During the drying, the residual monomer content in the polymer particles is also reduced, and last residues of the initiator are destroyed.

Thereafter, the dried polymer gel is ground and classified, and the apparatus used for grinding may typically be single or multistage roll mills, preferably two- or three-stage roll mills, pin mills, hammer mills or vibratory mills. Oversize gel lumps which often still have not dried on the inside are elastomeric, lead to problems in the grinding and are preferably removed before the grinding, which can be done in a simple manner by wind sifting or by means of a sieve (“guard sieve” for the mill). In view of the mill used, the mesh size of the sieve should be selected such that a minimum level of disruption resulting from oversize, elastomeric particles occurs.

Excessively large, insufficiently finely ground superabsorbent particles are perceptible as coarse particles in their predominant use, in hygiene products such as diapers; they also lower the mean initial swell rate of the superabsorbent. Both are undesired. Advantageously, coarse-grain polymer particles are therefore removed from the product. This is done by conventional classification processes, for example wind sifting, or by sieving through a sieve with a mesh size of at most 1000 μm, preferably at most 900 μm, more preferably at most 850 μm and most preferably at most 800 μm. For example, sieves of mesh size 700 μm, 650 μm or 600 μm are used. The coarse polymer particles (“oversize”) removed may, for cost optimization, be sent back to the grinding and sieving cycle or be processed further separately.

Polymer particles with too small a particle size lower the permeability (SFC). Advantageously, this classification therefore also removes fine polymer particles. This can, if sieving is effected, conveniently be used through a sieve of mesh size at most 300 μm, preferably at most 200 μm, more preferably at most 150 μm and most preferably at most 100 μm. The fine polymer particles (“undersize” or “fines”) removed can, for cost optimization, be sent back as desired to the monomer stream, to the polymerizing gel, or to the fully polymerized gel before the drying of the gel.

The mean particle size of the polymer particles removed as the product fraction is generally at least 200 μm, preferably at least 250 μm and more preferably at least 300 μm, and generally at most 600 μm and more preferably at most 500 μm. The proportion of particles with a particle size of at least 150 μm is generally at least 90% by weight, more preferably at least 95% by weight and most preferably at least 98% by weight. The proportion of particles with a particle size of at most 850 μm is generally at least 90% by weight, more preferably at least 95% by weight and most preferably at least 98% by weight.

In some other known production processes for superabsorbents, especially in the case of suspension polymerization, spray or dropletization polymerization, the selection of the process parameters defines the particle size distribution. These processes directly give rise to particulate superabsorbents of the desired particle size, such that grinding and sieving steps can often be dispensed with. In some processes (especially in the case of spray or dropletization polymerization), a dedicated drying step can often also be dispensed with.

The polymer thus prepared has superabsorbent properties and is covered by the term “superabsorbent”. Its CRC is typically comparatively high, but its AUL or SFC comparatively low. A surface nonpostcrosslinked superabsorbent of this type is often referred to as “base polymer” to distinguish it from a surface postcrosslinked superabsorbent produced therefrom.

The base polymer is optionally surface postcrosslinked.

Suitable postcrosslinkers are compounds which comprise groups which can form bonds with at least two functional groups of the superabsorbent particles. In the case of the acrylic acid/sodium acrylate-based superabsorbents prevalent on the market, suitable surface postcrosslinkers are compounds which comprise groups which can form bonds with at least two carboxylate groups. Preferred postcrosslinkers are amide acetals or carbamates of the general formula (III)

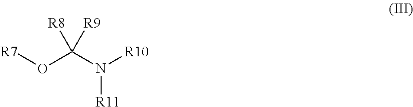

in which

R⁷ is C₁-C₁₂-alkyl, C₂-C₁₂-hydroxyalkyl, C₂-C₁₂-alkenyl or C₆-C₁₂-aryl,

R⁸ is X or OR¹²,

R⁹ is hydrogen, C₁-C₁₂-alkyl, C₂-C₁₂-hydroxyalkyl, C₂-C₁₂-alkenyl or C₆-C₁₂-aryl, or X,

R¹⁰ is C₁-C₁₂-alkyl, C₂-C₁₂-hydroxyalkyl, C₂-C₁₂-alkenyl or C₆-C₁₂-aryl,

R¹¹ is hydrogen, C₁-C₁₂-alkyl, C₂-C₁₂-hydroxyalkyl, C₂-C₁₂-alkenyl, C₁-C₁₂-acyl or C₆-C₁₂-aryl,

R¹² is C₁-C₁₂-alkyl, C₂-C₁₂-hydroxyalkyl, C₂-C₁₂-alkenyl or C₆-C₁₂-aryl and

X is a carbonyl oxygen common to the R⁸ and R⁹ radicals,

where R⁷ and R¹⁰ and/or R¹¹ and R¹² may be a bridged C₂-C₆-alkanediyl, and where the abovementioned R⁷ to R¹² radicals may also have a total of from one to two free valences and may be joined to at least one suitable base structure by these free valences,

or polyhydric alcohols, the polyhydric alcohol preferably having a molecular weight of less than 100 g/mol, preferably of less than 90 g/mol, more preferably of less than 80 g/mol, most preferably of less than 70 g/mol, per hydroxyl group, and no vicinal, geminal, secondary or tertiary hydroxyl groups, and polyhydric alcohols are either diols of the general formula (IVa)

HO—R¹³—OH (IVa)

in which R¹³ is either an unbranched alkylene radical of the formula —(CH₂)ₙ— where n is an integer from 3 to 20, preferably from 3 to 12, and both hydroxyl groups are terminal, or R¹³ is an unbranched, branched or cyclic alkylene radical, or polyols of the general formula (IVb)

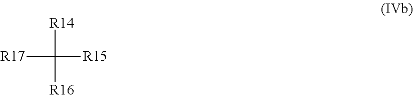

in which the R¹⁴, R¹⁵, R¹⁶, R¹⁷ radicals are each independently hydrogen, hydroxyl, hydroxymethyl, hydroxyethyloxymethyl, 1-hydroxyprop-2-yloxymethyl, 2-hydroxypropyloxymethyl, methyl, ethyl, n-propyl, isopropyl, n-butyl, n-pentyl, n-hexyl, 1,2-dihydroxyethyl, 2-hydroxyethyl, 3-hydroxypropyl or 4-hydroxybutyl and a total of 2, 3, or 4, preferably 2 or 3, hydroxyl groups are present, and not more than one of the R¹⁴, R¹⁵, R¹⁶ and R¹⁷ radicals is hydroxyl,

or cyclic carbonates of the general formula (V)

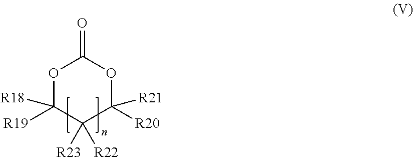

in which R¹⁸, R¹⁹, R²⁰, R²¹, R²² and R²³ are each independently hydrogen, methyl, ethyl, n-propyl, isopropyl, n-butyl, sec-butyl or isobutyl, and n is either 0 or 1,

or bisoxazolines of the general formula (VI)

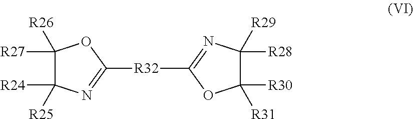

in which R²⁴, R²⁵, R²⁶, R²⁷, R²⁸, R²⁹, R³⁰ and R³¹ are each independently hydrogen, methyl, ethyl, n-propyl, isopropyl, n-butyl, sec-butyl or isobutyl, and R³² is a single bond, a linear, branched or cyclic C₂-C₁₂-alkylene radical, or a polyalkoxydiyl radical which is formed from one to ten ethylene oxide and/or propylene oxide units, as possessed, for example, by polyglycoldicarboxylic acids.

Preferred postcrosslinkers of the general formula (III) are 2-oxazolidones such as 2-oxazolidone and N-(2-hydroxyethyl)-2-oxazolidone, N-methyl-2-oxazolidone, N-acyl-2-oxazolidones such as N-acetyl-2-oxazolidone, 2-oxotetrahydro-1,3-oxazine, bicyclic amide acetals such as 5-methyl-1-aza-4,6-dioxabicyclo[3.3.0]octane, 1-aza-4,6-dioxabicyclo[3.3.0]octane and 5-isopropyl-1-aza-4,6-dioxabicyclo[3.3.0]octane, bis-2-oxazolidones and poly-2-oxazolidones.

Particularly preferred postcrosslinkers of the general formula (III) are 2-oxazolidone, N-methyl-2-oxazolidone, N-(2-hydroxyethyl)-2-oxazolidone and N-hydroxypropyl-2-oxazolidone.

Preferred postcrosslinkers of the general formula (IVa) are 1,3-propanediol, 1,5-pentanediol, 1,6-hexanediol and 1,7-heptanediol. Further examples of postcrosslinkers of the formula (IVa) are 1,3-butanediol, 1,8-octanediol, 1,9-nonanediol and 1,10-decanediol.

The diols are preferably water-soluble, the diols of the general formula (IVa) being water-soluble at 23° C. to an extent of at least 30% by weight, preferably to an extent of at least 40% by weight, more preferably to an extent of at least 50% by weight, most preferably at least to an extent of 60% by weight, for example 1,3-propanediol and 1,7-heptanediol. Even more preferred are those postcrosslinkers which are liquid at 25° C.

Preferred postcrosslinkers of the general formula (IVb) are butane-1,2,3-triol, butane-1,2,4-triol, glycerol, trimethylolpropane, trimethylolethane, pentaerythritol, 1- to 3-tuply (per molecule) ethoxylated glycerol, trimethylolethane or trimethylolpropane and 1- to 3-tuply (per molecule) propoxylated glycerol, trimethylolethane or trimethylolpropane. Additionally preferred are 2-tuply ethoxylated or propoxylated neopentyl glycol. Particular preference is given to 2-tuply and 3-tuply ethoxylated glycerol, neopentyl glycol, 2-methyl-1,3-propanediol and trimethylolpropane.

Preferred polyhydric alcohols (IVa) and (IVb) have, at 23° C., a viscosity of less than 3000 mPas, preferably less than 1500 mPas, more preferably less than 1000 mPas, especially preferably less than 500 mPas and very especially preferably less than 300 mPas. Particularly preferred postcrosslinkers of the general formula (V) are ethylene carbonate and propylene carbonate.

A particularly preferred postcrosslinker of the general formula (VI) is 2,2′-bis(2-oxazoline).

The preferred postcrosslinkers minimize side reactions and subsequent reactions which lead to volatile and hence malodorous compounds. The superabsorbents produced with the preferred postcrosslinkers are therefore odor-neutral even in the moistened state.

It is possible to use an individual postcrosslinker from the above selection or any mixtures of different postcrosslinkers.

The postcrosslinker is generally used in an amount of at least 0.001% by weight, preferably of at least 0.02% by weight, more preferably of at least 0.05% by weight, and generally at most 2% by weight, preferably at most 1% by weight, more preferably at most 0.3% by weight, for example at most 0.15% by weight or at most 0.095% by weight, based in each case on the mass of the base polymer contacted therewith (for example the sieve fraction in question).

The postcrosslinking is typically performed in such a way that a solution of the postcrosslinker is sprayed onto the dried base polymer particles. After the spray application, the polymer particles coated with postcrosslinker are dried thermally, and the postcrosslinking reaction can take place either before or during the drying. If surface postcrosslinkers with polymerizable groups are used, the surface postcrosslinking can also be effected by means of free-radically induced polymerization of such groups by means of common free-radical formers or else by means of high-energy radiation, for example UV light. This can be done in parallel with or instead of the use of postcrosslinkers which form covalent or ionic bonds to functional groups at the surface of the base polymer particles.

The spray application of the postcrosslinker solution is preferably carried out in mixers with moving mixing tools, such as screw mixers, disk mixers, paddle mixers or shovel mixers, or mixers with other mixing tools. Particular preference is given, however, to vertical mixers. It is also possible to spray on the postcrosslinker solution in a fluidized bed. Suitable mixers are obtainable, for example, as Pflugschar® plowshare mixers from Gebr. Lödige Maschinenbau GmbH, Elsener-Strasse 7-9, 33102 Paderborn, Germany, or as Schugi® Flexomix® mixers, Vrieco-Nauta® mixers or Turbulizer® mixers from Hosokawa Micron BV, Gildenstraat 26, 7000 AB Doetinchem, the Netherlands.

The spray nozzles usable are not subject to any restriction. Suitable nozzles and atomization systems are described, for example, in the following references: Zerstäuben von Flüssigkeiten [Atomization of Liquids], Expert-Verlag, vol. 660, Reihe Kontakt & Studium, Thomas Richter (2004) and in Zerstäubungstechnik [Atomization Technology], Springer-Verlag, VDI-Reihe, Günter Wozniak (2002). It is possible to use mono- and polydisperse spray systems. Among the polydisperse systems, one-phase pressurized nozzles (jet- or lamella-forming), rotary atomizers, two-phase atomizers, ultrasound atomizers and impingement nozzles are suitable. In the case of the two-phase atomizers, the liquid phase can be mixed with the gas phase either internally or externally. The spray profile of the nozzles is uncritical and may assume any desired form, for example a round jet, flat jet, wide angle round beam or circular ring spray profile. It is advantageous to use a nonoxidizing gas if two-phase atomizers are used, particular preference being given to nitrogen, argon or carbon dioxide. The liquid to be sprayed can be supplied to such nozzles under pressure. The atomization of the liquid to be sprayed can be effected by expanding it in the nozzle bore on attainment of a particular minimum velocity. In addition, it is also possible to use one-phase nozzles for the inventive purpose, for example slit nozzles or swirl chambers (full-cone nozzles) (for example from Düsen-Schlick GmbH, Germany, or from Spraying Systems Germany GmbH, Germany). Such nozzles are also described in EP 0 534 228 A1 and EP 1 191 051 A2.

The postcrosslinkers are typically used in the form of an aqueous solution. When exclusively water is used as the solvent, a surfactant or deagglomeration assistant is advantageously added to the postcrosslinker solution or actually to the base polymer. This improves the wetting behavior and reduces the tendency to form lumps.

All anionic, cationic, nonionic and amphoteric surfactants are suitable as deagglomeration assistants, but preference is given to nonionic and amphoteric surfactants for skin compatibility reasons. The surfactant may also comprise nitrogen. For example, sorbitan monoesters, such as sorbitan monococoate and sorbitan monolaurate, or ethoxylated variants thereof, for example Polysorbat 20®, are added. Further suitable deagglomeration assistants are the ethoxylated and alkoxylated derivatives of 2-propylheptanol, which are sold under the Lutensol XL® and Lutensol XP® brands (BASF SE, Carl-Bosch-Strasse 38, 67056 Ludwigshafen, Germany).

The deagglomeration assistant can be metered in separately or added to the postcrosslinker solution. Preference is given to simply adding the deagglomeration assistant to the postcrosslinker solution.

The amount of the deagglomeration assistant used, based on base polymer, is, for example, from 0 to 0.1% by weight, preferably from 0 to 0.01% by weight, more preferably from 0 to 0.002% by weight. The deagglomeration assistant is preferably metered in such that the surface tension of an aqueous extract of the swollen base polymer and/or of the swollen postcrosslinked water-absorbing polymer at 23° C. is at least 0.060 N/m, preferably at least 0.062 N/m, more preferably at least 0.065 N/m, and advantageously at most 0.072 N/m.

The aqueous postcrosslinker solution may, as well as the at least one postcrosslinker, also comprise a cosolvent. The penetration depth of the postcrosslinker into the polymer particles can be adjusted via the content of nonaqueous solvent and total amount of solvent. Industrially highly suitable cosolvents are C1-C6-alcohols such as methanol, ethanol, n-propanol, isopropanol, n-butanol, sec-butanol, tert-butanol or 2-methyl-1-propanol, C2-C5-diols such as ethylene glycol, 1,2-propylene glycol or 1,4-butanediol, ketones such as acetone, or carboxylic esters such as ethyl acetate. A disadvantage of many of these cosolvents is that they have typical intrinsic odors.

The cosolvent itself is ideally not a postcrosslinker under the reaction conditions. However, it may arise in the boundary case and depending on the residence time and temperature that the cosolvent contributes partly to crosslinking. This is the case especially when the postcrosslinker is relatively slow to react and can therefore also constitute its own cosolvent, as is the case, for example, when cyclic carbonates of the general formula (V), diols of the general formula (IVa) or polyols of the general formula (IVb) are used. Such postcrosslinkers can also be used in the function as a cosolvent in a mixture with more reactive postcrosslinkers, since the actual postcrosslinking reaction can then be performed at lower temperatures and/or with shorter residence times than in the absence of the more reactive crosslinker. Since the cosolvent is used in relatively large amounts and some also remains in the product, it must not be toxic.
In the process according to the invention, the diols of the general formula (IVa), the polyols of the general formula (IVb) and the cyclic carbonates of the general formula (V) are also suitable as cosolvents. They fulfill this function in the presence of a reactive postcrosslinker of the general formula (III) and/or (VI) and/or of a di- or triglycidyl compound. Preferred cosolvents in the process according to the invention are, however, especially the diols of the general formula (IVa), especially when a reaction of the hydroxyl groups is hindered sterically by neighboring groups. Although such diols are also suitable in principle as postcrosslinkers, this requires significantly higher reaction temperatures or optionally higher use amounts than for sterically unhindered diols.

Particularly preferred combinations of low-reactivity postcrosslinker as a cosolvent and reactive postcrosslinker are combinations of preferred polyhydric alcohols, diols of the general formula (IVa) and polyols of the general formula (IVb), with amide acetals or carbamates of the general formula (III).

Suitable combinations are, for example, 2-oxazolidone/1,2-propanediol and N-(2-hydroxyethyl)-2-oxazolidone/1,2-propanediol, and also ethylene glycol diglycidyl ether/1,2-propanediol.

Very particularly preferred combinations are 2-oxazolidone/1,3-propanediol and N-(2-hydroxyethyl)-2-oxazolidone/1,3-propanediol.

Further preferred combinations are those with ethylene glycol diglycidyl ether or glyceryl di- or triglycidyl ether with the following solvents, cosolvents or cocrosslinkers: isopropanol, 1,3-propanediol, 1,2-propylene glycol or mixtures thereof.

Further preferred combinations are those with 2-oxazolidone or (2-hydroxyethyl)-2-oxazolidone in the following solvents, cosolvents or cocrosslinkers: isopropanol, 1,3-propanediol, 1,2-propylene glycol, ethylene carbonate, propylene carbonate or mixtures thereof.

Frequently, the concentration of the cosolvent in the aqueous postcrosslinker solution is from 15 to 50% by weight, preferably from 15 to 40% by weight and more preferably from 20 to 35% by weight, based on the postcrosslinker solution. In the case of cosolvents which have only limited miscibility with water, the aqueous postcrosslinker solution will advantageously be adjusted such that only one phase is present, optionally by lowering the concentration of the cosolvent.

In a preferred embodiment, no cosolvent is used. The postcrosslinker is then employed only as a solution in water, optionally with addition of a deagglomeration assistant.

The concentration of the at least one postcrosslinker in the aqueous postcrosslinker solution is typically from 1 to 20% by weight, preferably from 1.5 to 10% by weight and more preferably from 2 to 5% by weight, based on the postcrosslinker solution.

The total amount of the postcrosslinker solution based on base polymer is typically from 0.3 to 15% by weight and preferably from 2 to 6% by weight.

The actual surface postcrosslinking by reaction of the surface postcrosslinker with functional groups at the surface of the base polymer particles is usually carried out by heating the base polymer wetted with surface postcrosslinker solution, typically referred to as “drying” (but not to be confused with the above-described drying of the polymer gel from the polymerization, in which typically very much more liquid has to be removed). The drying can be effected in the mixer itself, by heating the jacket, by means of heat exchange surfaces or by blowing in warm gases. Simultaneous admixing of the superabsorbent with surface postcrosslinker and drying can be effected, for example, in a fluidized bed drier. The drying is, however, usually carried out in a downstream drier, for example a tray drier, a rotary tube oven, a paddle or disk drier or a heatable screw. Suitable driers are obtainable, for example, as Solidair® or Torusdisc® driers from Bepex International LLC, 333 N.E. Taft Street, Minneapolis, Minn. 55413, U.S.A., or as paddle or shovel driers or else as fluidized bed driers from Nara Machinery Co., Ltd., European office, Europaallee 46, 50226 Frechen, Germany.

It is possible to heat the polymer particles by means of contact surfaces in a downstream drier for the purpose of drying and performing the surface postcrosslinking, or by means of warm inert gas supply, or by means of a mixture of one or more inert gases with steam, or only with steam alone. In the case of supply of the heat by means of contact surfaces, it is possible to perform the reaction under inert gas at slightly or completely reduced pressure. In the case of use of steam for direct heating of the polymer particles, it is desirable in accordance with the invention to operate the drier under standard pressure or elevated pressure. In this case, it may be advisable to split up the postcrosslinking step into a heating step with steam and a reaction step under inert gas but without steam. This can be achieved in one or more apparatuses. According to the invention, the polymer particles can be heated with steam as early as in the postcrosslinking mixer. The base polymer used may still have a temperature of from 10 to 120° C. from preceding process steps; the postcrosslinker solution may have a temperature of from 0 to 70° C. In particular, the postcrosslinker solution can be heated to reduce the viscosity.

Preferred drying temperatures are in the range of 100 to 250° C., preferably 120 to 220° C., more preferably 130 to 210° C. and most preferably 150 to 200° C. The preferred residence time at this temperature in the reaction mixer or drier is preferably at least 10 minutes, more preferably at least 20 minutes, most preferably at least 30 minutes, and typically at most 60 minutes. Typically, the drying is conducted such that the superabsorbent has a residual moisture content of generally at least 0.1% by weight, preferably at least 0.2% by weight and most preferably at least 0.5% by weight, and generally at most 15% by weight, preferably at most 10% by weight and more preferably at most 8% by weight.

The postcrosslinking may take place under standard atmospheric conditions. “Standard atmospheric conditions” means that no technical precautions are taken in order to reduce the partial pressure of oxidizing gases, such as that of atmospheric oxygen, in the apparatus in which the postcrosslinking reaction predominantly takes place (the “postcrosslinking reactor”, typically the drier). However, preference is given to performing the postcrosslinking reaction under reduced partial pressure of oxidizing gases. Oxidizing gases are substances which, at 23° C., have a vapor pressure of at least 1013 mbar and act as oxidizing agents in combustion processes, for example oxygen, nitrogen oxide and nitrogen dioxide, especially oxygen. The partial pressure of oxidizing gases is preferably less than 140 mbar, preferably less than 100 mbar, more preferably less than 50 mbar and most preferably less than 10 mbar. When the thermal postcrosslinking is carried out at ambient pressure, i.e. at a total pressure around 1013 mbar, the total partial pressure of the oxidizing gases is determined by their proportion by volume. The proportion of the oxidizing gases is preferably less than 14% by volume, preferably less than 10% by volume, more preferably less than 5% by volume and most preferably less than 1% by volume.

The postcrosslinking can be carried out under reduced pressure, i.e. at a total pressure of less than 1013 mbar. The total pressure is typically less than 670 mbar, preferably less than 480 mbar, more preferably less than 300 mbar and most preferably less than 200 mbar. When drying and postcrosslinking are carried out under air with an oxygen content of 20.8% by volume, the partial oxygen pressures corresponding to the abovementioned total pressures are 139 mbar (670 mbar), 100 mbar (480 mbar), 62 mbar (300 mbar) and 42 mbar (200 mbar), the respective total pressures being in the brackets. Another means of lowering the partial pressure of oxidizing gases is the introduction of nonoxidizing gases, especially inert gases, into the apparatus used for postcrosslinking. Suitable inert gases are substances which are present in gaseous form in the postcrosslinking drier at the postcrosslinking temperature and the given pressure and do not have an oxidizing action on the constituents of the drying polymer particles under these conditions, for example nitrogen, carbon dioxide, argon, steam, preference being given to nitrogen. The amount of inert gas is generally from 0.0001 to 10 m³, preferably from 0.001 to 5 m³, more preferably from 0.005 to 1 m³ and most preferably from 0.005 to 0.1 m³, based on 1 kg of superabsorbent.

In the process according to the invention, the inert gas, if it does not comprise steam, can be blown into the postcrosslinking drier via nozzles; however, particular preference is given to adding the inert gas to the polymer particle stream via nozzles actually within or just upstream of the mixer, by admixing the superabsorbent with surface postcrosslinker.

It will be appreciated that vapors of cosolvents removed from the drier can be condensed again outside the drier and optionally recycled.

In a preferred embodiment of the present invention, polyvalent cations are applied to the particle surface in addition to the postcrosslinkers before, during or after the postcrosslinking. This is in principle a further surface postcrosslinking by means of ionic noncovalent bonds, but is occasionally also referred to as “complexation” with the metal ions in question or simply as “coating” with the substances in question (the “complexing agent”).

This application of polyvalent cations is effected by spray application of solutions of di- or polyvalent cations, usually di-, tri- or tetravalent metal cations, but also polyvalent cations such as polymers formed, in a formal sense, entirely or partly from vinylamine monomers, such as partly or fully hydrolyzed polyvinylamide (so-called “polyvinylamine”), whose amine groups are always—even at very high pH values—present partly in protonated form to give ammonium groups. Examples of usable divalent metal cations are especially the divalent cations of metals of groups 2 (especially Mg, Ca, Sr, Ba), 7 (especially Mn), 8 (especially Fe), 9 (especially Co), 10 (especially Ni), 11 (especially Cu) and 12 (especially Zn) of the Periodic Table of the Elements. Examples of usable trivalent metal cations are especially the trivalent cations of metals of groups 3 including the lanthanides (especially Sc, Y, La, Ce), 8 (especially Fe), 11 (especially Au) and 13 (especially Al) of the Periodic Table of the Elements. Examples of usable tetravalent cations are especially the tetravalent cations of metals from the lanthanides (especially Ce) and group 4 (especially Ti, Zr, Hf) of the Periodic Table of the Elements. The metal cations can be used either alone or as a mixture with one another. Particular preference is given to the use of trivalent metal cations. Very particular preference is given to the use of aluminum cations.

Among the metal cations mentioned, suitable metal salts are all of those which possess sufficient solubility in the solvent to be used. Particularly suitable metal salts are those with weakly complexing anions, for example chloride, nitrate and sulfate, hydrogensulfate, carbonate, hydrogencarbonate, nitrate, phosphate, hydrogenphosphate, or dihydrogenphosphate. Preference is given to salts of mono- and dicarboxylic acids, hydroxy acids, keto acids and amino acids, or basic salts. Examples are acetates, propionates, tartrates, maleates, citrates, lactates, malates and succinates Likewise preferred is the use of hydroxides. Particular preference is given to the use of 2-hydroxycarboxylic salts such as citrates and lactates. Examples of particularly preferred metal salts are alkali metal and alkaline earth metal aluminates and hydrates thereof, for instance sodium aluminate and hydrates thereof, aluminum acetate, aluminum propionate, aluminum citrate and aluminum lactate.

The cations and salts mentioned can be used in pure form or as a mixture of different cations or salts. The salts of the di- and/or trivalent metal cation used may comprise further secondary constituents such as still unneutralized carboxylic acid and/or alkali metal salts of the neutralized carboxylic acid. Preferred alkali metal salts are those of sodium and potassium, and those of ammonium. They are typically used in the form of an aqueous solution which is obtained by dissolving the solid salts in water, or is preferably obtained directly as such, which avoids any drying and purification steps. Advantageously, it is also possible to use the hydrates of the salts mentioned, which often dissolve more rapidly in water than the anhydrous salts.

The amount of metal salt used is generally at least 0.001% by weight, preferably at least 0.01% by weight and more preferably at least 0.1% by weight, for example at least 0.4% by weight, and generally at most 5% by weight, preferably at most 2.5% by weight and more preferably at most 1% by weight, for example at most 0.7% by weight, based in each case on the mass of the base polymer.

The salt of the polyvalent metal cation can be used in the form of a solution or suspension. Solvents for the metal salts which may be employed are water, alcohols, DMF, DMSO and mixtures of these components. Particular preference is given to water and water/alcohol mixtures, for example water/methanol, water/1,2-propanediol and water/1,3-propanediol.

The treatment of the base polymer with solution of a polyvalent cation is carried out in the same manner as the treatment with surface postcrosslinker, including the drying step. Surface postcrosslinker and polyvalent cation can be sprayed on in a combined solution or as separate solutions. The spray application of the metal salt solution to the superabsorbent particles may either precede or follow the surface postcrosslinking. In a particularly preferred process, the spray application of the metal salt solution is effected in the same step together with the spray application of the crosslinker solution, in which case the two solutions are sprayed on separately in succession or simultaneously via two nozzles, or crosslinker solution and metal salt solution can be sprayed on jointly via one nozzle.

If a drying step is carried out after the surface postcrosslinking and/or treatment with complexing agent, it is advantageous but not absolutely necessary to cool the product after the drying. The cooling can be effected continuously or batchwise; to this end, the product is conveniently conveyed continuously into a cooler arranged downstream of the drier. Any apparatus known for removal of heat from pulverulent solids can be used for this purpose, more particularly any device mentioned above as drying apparatus, except that it is charged not with a heating medium but with a cooling medium, for example with cooling water, such that no heat is introduced into the superabsorbent via the walls and, according to the construction, also via the stirring elements or other heat exchange surfaces, and is instead removed therefrom. Preference is given to the use of coolers in which the product is moved, i.e. cooled mixers, for example shovel coolers, disk coolers or paddle coolers. The superabsorbent can also be cooled in a fluidized bed by injecting a cooled gas such as cold air. The cooling conditions are adjusted so as to obtain a superabsorbent with the temperature desired for further processing. Typically, a mean residence time in the cooler of generally at least 1 minute, preferably at least 3 minutes and more preferably at least 5 minutes, and generally at most 6 hours, preferably at most 2 hours and more preferably at most 1 hour is established, and the cooling performance is such that the product obtained has a temperature of generally at least 0° C., preferably at least 10° C. and more preferably at least 20° C., and generally at most 100° C., preferably at most 80° C. and more preferably at most 60° C.

The surface postcrosslinked superabsorbent is optionally ground and/or sieved in a customary manner. Grinding is typically not required here, but the removal by sieving of agglomerates or fines formed is usually appropriate for establishment of the desired particle size distribution of the product. Agglomerates and fines are either discarded or preferably recycled into the process in a known manner at a suitable point; agglomerates after comminution. The particle sizes desired for surface postcrosslinked superabsorbents are the same as for base polymers.

Phosphonic acid derivative of the formula (II) is added in the process according to the invention after the drying or after any surface postcrosslinking operation which is performed. A suitable apparatus for this purpose is any which can mix the phosphonic acid derivative into the superabsorbent with sufficient homogeneity. It is particularly convenient and therefore preferable to add the phosphonic acid derivative in the cooler.

The phosphonic acid derivative of the formula (II) is generally added in an amount of at least 0.01% by weight, preferably at least 0.1% by weight and more preferably at least 0.2% by weight, and generally at most 2.0% by weight, preferably at most 1.0% by weight and more preferably at most 0.7% by weight, based in each case on the total amount of superabsorbent.

The inventive superabsorbents are obtainable by the process according to the invention.

Optionally, the inventive superabsorbents produced by the process according to the invention are provided with further additives which stabilize against discoloration. For this purpose, all known additives can be used in the manner known for each in the process according to the invention.

Optionally, the inventive superabsorbent is also admixed with at least one inorganic water-insoluble particulate solid. In principle, any inorganic water-insoluble powder is suitable for this purpose. Examples are generally solid, chemically inert substances (i.e. those which are not disruptive in the superabsorbent) such as oxides, oxide hydroxides, hydroxides, sulfates, carbonates, zeolites, inorganic pigments, minerals or clays. Examples are sulfates such as magnesium sulfate or barium sulfate, carbonates such as calcium carbonate, magnesium carbonate, zinc carbonate or dolomite, silicates such as calcium silicate or magnesium silicate, carbides such as perlite or silicon carbide, diatomaceous earth or fly ash.

Suitable oxides are the metal oxides of groups 2 to 14 of the Periodic Table of the Elements, including the lanthanides and actinides. Examples of particularly suitable oxides are magnesium oxide, calcium oxide, strontium oxide, barium oxide, titanium dioxide, zirconium dioxide, vanadium oxide, chromium oxide, molybdenum oxide, tungsten oxide, manganese dioxide, iron oxide, cobalt oxide, nickel oxide, copper oxide, zinc oxide, boron oxide, aluminum oxide (boehmite and others), silicon dioxide, tin oxide, lead oxide, lanthanum oxide or cerium oxide. For clarification: The use of a trivial name for metal oxides is not supposed to be a statement about the valency of the metal and the stoichiometry of the oxide. If an element forms more than one oxide, all are generally suitable. In the individual case, the oxide is selected according to considerations specific to the individual case, for example by cost, toxicity, stability or color. Examples of particularly suitable oxides are titanium dioxide, especially in the anatase or rutile polymorphs, precipitated silicon dioxide or silicon dioxide produced by pyrolysis.

Clays are silicates or aluminosilicates, which are typically obtained by mining of natural sediments and occasionally also further processing thereof. However, some clays are produced synthetically.

It is also possible to use mixtures of two or more of these substances.

The inorganic water-insoluble solid is particulate; it is in pulverulent form. The mean particle size is typically in the range of at least 0.001 μm, preferably at least 0.002 μm, more preferably at least 0.005 and most preferably at least 0.01 μm, and generally at most 500 μm, preferably at most 200 μm, more preferably at most 100 μm and most preferably at most 50 μm. The particles may themselves be aggregates or agglomerates of smaller primary particles. The particle size can be determined by means of sieve analysis, but a simpler and therefore preferred method is the determination of the particle size by means of laser diffraction technology. These processes are well known and are conducted routinely on suitable and commercially available equipment.

The aforementioned optional further stabilizers against discoloration and the inorganic water-insoluble particulate solid are, when they are added, added in amounts of in each case generally at least 0.0001% by weight, preferably at least 0.001% by weight and more preferably at least 0.025% by weight, and generally at most 3% by weight, preferably at most 2% by weight and more preferably at most 0.5% by weight, based in each case on the total weight of the inventive superabsorbent. In general, in the case of the inventive superabsorbent comprising alkaline earth metal salt, a smaller amount of known stabilizers against discoloration is needed than without alkaline earth metal salt.

Superabsorbents can be mixed with the optional stabilizers against discoloration and the optional inorganic water-insoluble particulate solid by any known mixing process. Stabilizers against discoloration, when in solid form, and the inorganic water-insoluble particulate solid, are incorporated by mixing in substance or as a suspension in a solvent or suspension medium, and, when in dissolved or liquid form, optionally also in solution or liquid form. Due to easier homogeneous distribution, the stabilizers are preferably incorporated into the superabsorbent by mixing as a powder or suspension. This does not necessarily produce a physical mixture separable in a simple manner by mechanical measures. The additives may quite possibly enter into a more definite bond with the superabsorbent, for example in the form of a comparatively firmly adhering surface layer or in the form of particles adhering firmly to the surface of the superabsorbent particles. The mixing of the additives into the known superabsorbent can quite possibly also be understood and referred to as “coating”.

If a solution or suspension is used for coating, the solvent or suspension medium used is a solvent or suspension medium which is chemically compatible both with the superabsorbent and with the additive, i.e. does not enter into any undesired chemical reactions therewith. Typically, water or an organic solvent is used, for example an alcohol or polyol, or mixtures thereof. Examples of suitable solvents or suspension media are water, isopropanol/water, 1,3-propanediol/water and propylene glycol/water, where the mixing ratio by mass is preferably from 20:80 to 40:60. If a suspension medium is used for the stabilizers to be used in accordance with the invention or the inorganic particulate solid, water is preferred. A surfactant can be added to the solution or suspension.

Optional stabilizers and other additives are, if they are not added to the monomer mixture or the polymerizing gel, generally mixed with the superabsorbent in exactly the same way as the solution or suspension which comprises a surface postcrosslinker and is applied to the superabsorbent for surface postcrosslinking. The additive can be applied as a constituent of the solution applied for surface postcrosslinking or of one of the components thereof to an (as yet) nonpostcrosslinked superabsorbent (a “base polymer”), i.e. the additive can be added to the solution of the surface postcrosslinker or to one of the components thereof. The superabsorbent coated with surface postcrosslinker and additives then passes through the further process steps required for surface postcrosslinking, for example a thermally induced reaction of the surface postcrosslinker with the superabsorbent. This process is comparatively simple and economically viable.

If ultrahigh stability against discoloration is essential, phosphonic acid derivative and optional stabilizers and additives are applied in a dedicated process step after the surface postcrosslinking, conveniently in the cooler. If phosphonic acid derivative, stabilizers and additives are applied as a solution or suspension, they can be applied to the already surface postcrosslinked superabsorbent in the same mixing apparatuses as described for the application of the surface postcrosslinker to the base polymer. Usually, but not necessarily, this is followed by heating, just like in the surface postcrosslinking step, in order to dry the superabsorbent again. The temperature established in this drying operation is then, however, generally at most 110° C., preferably at most 100° C. and more preferably at most 90° C., in order to prevent undesired reactions of the additive. The temperature is adjusted such that, in view of the residence time in the drying unit, the desired water content of the superabsorbent is achieved. It is also entirely possible and convenient to add the additive individually or together with other customary assistants, for example dust binders, anticaking agents or water for remoisturization of the superabsorbent. The temperature of the polymer particles in this case is between 0° C. and 190° C., preferably less than 160° C., more preferably less than 130° C., even more preferably less than 100° C. and most preferably less than 70° C. The polymer particles are optionally cooled rapidly after coating to temperatures below any decomposition temperature of the additive.

It is optionally possible to additionally apply to the surface of the superabsorbent particles, whether unpostcrosslinked or postcrosslinked, in any process step of the preparation process, if required, all known coatings, such as film-forming polymers, thermoplastic polymers, dendrimers, polycationic polymers (for example polyvinylamine, polyethyleneimine or polyallylamine), or all water-soluble mono- or polyvalent metal salts known to those skilled in the art, for example aluminum sulfate, sodium salts, potassium salts, zirconium salts or iron salts. Examples of useful alkali metal salts are sodium and potassium sulfate, and sodium and potassium lactates, citrates and sorbates. This allows additional effects, for example a reduced caking tendency of the end product or of the intermediate in the particular process step of the production process, improved processing properties or a further enhanced saline flow conductivity (SFC), to be achieved. When the additives are used and sprayed on in the form of dispersions, they are preferably used as aqueous dispersions, and preference is given to additionally applying an antidusting agent to fix the additive on the surface of the superabsorbent. The antidusting agent is then either added directly to the dispersion of the inorganic pulverulent additive; optionally, it can also be added as a separate solution before, during or after the application of the inorganic pulverulent additive by spray application. Most preferred is the simultaneous spray application of postcrosslinking agent, antidusting agent and pulverulent inorganic additive in the postcrosslinking step. In a further preferred process variant, the antidusting agent is, however, added separately in the cooler, for example by spray application from above, below or from the side. Particularly suitable antidusting agents which can also serve to fix pulverulent inorganic additives on the surface of the water-absorbing polymer particles are polyethylene glycols with a molecular weight of 400 to 20 000 g/mol, polyglycerol, 3- to 100-tuply ethoxylated polyols, such as trimethylolpropane, glycerol, sorbitol and neopentyl glycol. Particularly suitable are 7- to 20-tuply ethoxylated glycerol or trimethylolpropane, for example Polyol TP 70® (Perstorp, Sweden). The latter have the advantage, more particularly, that they lower the surface tension of an aqueous extract of the water-absorbing polymer particles only insignificantly.

It is equally possible to adjust the inventive superabsorbent to a desired water content by adding water.

All coatings, solids, additives and assistants can each be added in separate process steps, but the most convenient method is usually to add them—if they are not added during the admixing of the base polymer with surface postcrosslinking agent—to the superabsorbent in the cooler, for instance by spray application of a solution or addition in fine solid form or in liquid form. The addition of the phosphonic acid derivative in the cooler is also a convenient and preferred embodiment.

The inventive superabsorbents generally have a centrifuge retention capacity (CRC, for test method see below) of at least 5 g/g, preferably of at least 10 g/g and more preferably of at least 20 g/g. Typically, it is not more than 40 g/g for surface postcrosslinked superabsorbents, but it is often higher for base polymers.

The inventive superabsorbents have, if they have been surface postcrosslinked, typically an absorption under load (AUL0.7 psi, for test method see below) of at least 10 g/g, preferably at least 14 g/g, more preferably at least 18 g/g and most preferably at least 22 g/g, and typically not more than 30 g/g.

The L value of the superabsorbent (CIE color number) is, in the unstored state, typically at least 75, preferably at least 80, more preferably at least 85, and at most 100.

The a value of the superabsorbent (CIE color number) is, in the unstored state, typically from −2.5 to +2.5, preferably from −2.0 to +2.0, more preferably from −1.5 to +1.5.

The b value of the superabsorbent (CIE color number) in the unstored state is typically from 0 to 12, preferably from 2 to 11.

According to the relatively high-stress aging test described below, the inventive superabsorbents, after measurement, has results worsened only to a relatively minor degree for the L and a values compared to the unstored state, more particularly b values of preferably not more than 13, more preferably not more than 12. A b value above 12 is critical in feminine hygiene articles and ultrathin diapers; a b value of more than 15 is critical even in standard diapers, since this discoloration can be perceived by the consumer on use.

The present invention further provides hygiene articles comprising inventive superabsorbents, preferably ultrathin diapers, comprising an absorbent layer consisting of 50 to 100% by weight, preferably 60 to 100% by weight, more preferably 70 to 100% by weight, especially preferably 80 to 100% by weight and very especially preferably 90 to 100% by weight of inventive superabsorbent, of course not including the envelope of the absorbent layer.

Very particularly advantageously, the inventive superabsorbents are also suitable for production of laminates and composite structures, as described, for example, in US 2003/0181115 and US 2004/0019342. In addition to the hotmelt adhesives described in both documents for production of such novel absorbent structures, and especially the fibers, described in US 2003/0181115, composed of hotmelt adhesives to which the superabsorbent particles are bound, the inventive superabsorbents are also suitable for production of entirely analogous structures using UV-crosslinkable hotmelt adhesives, which are sold, for example, as AC-Resin® (BASF SE, Germany). These UV-crosslinkable hotmelt adhesives have the advantage of already being processable at 120 to 140° C.; they therefore have better compatibility with many thermoplastic substrates. A further significant advantage is that UV-crosslinkable hotmelt adhesives are very safe in toxicological terms and also do not cause any evaporation in the hygiene articles. A very significant advantage in connection with the inventive superabsorbents is the property of the UV-crosslinkable hotmelt adhesives of not tending to yellow during processing and crosslinking. This is especially advantageous when ultrathin or partly transparent hygiene articles are to be produced. The combination of the inventive superabsorbents with UV-crosslinkable hotmelt adhesives is therefore particularly advantageous. Suitable UV-crosslinkable hotmelt adhesives are described, for example, in EP 0 377 199 A2, EP 0 445 641A1, U.S. Pat. No. 5,026,806, EP 0 655 465 A1 and EP 0 377 191A2.

The inventive superabsorbent can also be used in other fields of industry in which liquids, especially water or aqueous solutions, are absorbed. These fields are, for example, storage, packaging, transport (as constituents of packaging material for water- or moisture-sensitive articles, for instance for flower transport, and also as protection against mechanical effects); animal hygiene (in cat litter); food packaging (transport of fish, fresh meat; absorption of water, blood in fresh fish or meat packaging); medicine (wound plasters, water-absorbing material for burn dressings or for other weeping wounds), cosmetics (carrier material for pharmaceutical chemicals and medicaments, rheumatic plasters, ultrasonic gel, cooling gel, cosmetic thickeners, sunscreen); thickeners for oil/water or water/oil emulsions; textiles (moisture regulation in textiles, shoe insoles, for evaporative cooling, for instance in protective clothing, gloves, headbands); chemical engineering applications (as a catalyst for organic reactions, for immobilization of large functional molecules such as enzymes, as an adhesive in agglomerations, heat stores, filtration aids, hydrophilic components in polymer laminates, dispersants, liquefiers); as assistants in powder injection molding, in the building and construction industry (installation, in loam-based renders, as a vibration-inhibiting medium, assistants in tunnel excavations in water-rich ground, cable sheathing); water treatment, waste treatment, water removal (deicers, reusable sand bags); cleaning; agrochemical industry (irrigation, retention of melt water and dew deposits, composting additive, protection of forests from fungal/insect infestation, retarded release of active ingredients to plants); for firefighting or for fire protection; coextrusion agents in thermoplastic polymers (for example for hydrophilization of multilayer films); production of films and thermoplastic moldings which can absorb water (e.g. films which store rain and dew for agriculture; films comprising superabsorbents for maintaining freshness of fruit and vegetables which are packaged in moist films; superabsorbent-polystyrene coextrudates, for example for packaging foods such as meat, fish, poultry, fruit and vegetables); or as a carrier substance in active ingredient formulations (pharmaceuticals, crop protection).

The inventive articles for absorption of liquid differ from known examples in that they comprise the inventive superabsorbent.

Also found has been a process for producing articles for absorption of liquid, especially hygiene articles, which comprises using at least one inventive superabsorbent in the production of the article in question. In addition, processes for producing such articles using superabsorbent are known.

### Test Methods

The superabsorbent is tested by the test methods described below.

The standard test methods described hereinafter and designated “WSP” are described in: “Standard Test Methods for the Nonwovens Industry”, 2005 edition, published jointly by the Worldwide Strategic Partners EDANA (European Disposables and Nonwovens Association, Avenue Eugène Plasky, 157, 1030 Brussels, Belgium, www.edana.org) and INDA (Association of the Nonwoven Fabrics Industry, 1100 Crescent Green, Suite 115, Cary, N.C. 27518, U.S.A., www.inda.org). This publication is available both from EDANA and from INDA.

All measurements described below should, unless stated otherwise, be conducted at an ambient temperature of 23±2° C. and a relative air humidity of 50±10%. The superabsorbent particles are mixed thoroughly before the measurement unless stated otherwise.

### Centrifuge Retention Capacity (CRC)

The centrifuge retention capacity of the superabsorbent is determined by the standard test method No. WSP 241.5-05 “Centrifuge retention capacity”.

### Absorbency Under a Load of 0.7 Psi (AUL0.7 Psi)

The absorbency under a load of 4826 Pa (0.7 psi) of the superabsorbent is determined analogously to the standard test method No. WSP 242.2-05 “Absorption under pressure”, except using a weight of 49 g/cm² (leads to a load of 0.7 psi) instead of a weight of 21 g/cm² (leads to a load of 0.3 psi).

### Extractables (16 h)

The proportion of extractables in the superabsorbent is determined by Standard test method No. WSP 270.2-05 “Determination of Extractable Polymer Content by Potentiometric Titration”.

### Moisture Content of the Superabsorbent (Residual Moisture, Water Content)

The water content of the superabsorbent particles is determined by the standard test method No. WSP 230.2-05 “Moisture content”.

### Saline Flow Conductivity (SFC)

The saline flow conductivity of a swollen gel layer formed by the superabsorbent as a result of liquid absorption is determined under a pressure of 0.3 psi (2068 Pa), as described in EP 0 640 330 A1, as the gel layer permeability of a swollen gel layer of superabsorbent particles, the apparatus described in the aforementioned patent application on page 19 and in FIG. 8 being modified to the effect that the glass frit (40) is not used, and the plunger (39) consists of the same polymer material as the cylinder (37) and now comprises 21 bores of equal size distributed homogeneously over the entire contact area. The procedure and evaluation of the measurement remain unchanged from EP 0 640 330 A1. The flow is detected automatically.

The saline flow conductivity (SFC) is calculated as follows:

SFC [cm³s/g]=(Fg(t=0)×L0)/(d×A×WP)

where Fg(t=0) is the flow of NaCl solution in g/s, which is obtained using linear regression analysis of the Fg(t) data of the flow determinations by extrapolation to t=0, L0 is the thickness of the gel layer in cm, d is the density of the NaCl solution in g/cm³, A is the area of the gel layer in cm², and WP is the hydrostatic pressure over the gel layer in dyn/cm².

### Permeability (FSGBP, “Free Swell Gel Bed Permeability”)

The permeability is determined as described in US 2005/0 256 757 A1 in paragraphs [0061] to [0075].

### CIE Color Number (L, a, b)

The color analysis is carried out according to the CIELAB method (Hunterlab, volume 8, 1996, book 7, pages 1 to 4) with a “LabScan XE S/N LX17309” colorimeter (HunterLab, Reston, U.S.A.). This method describes the colors via the coordinates L, a and b of a three-dimensional system. L indicates the brightness, where L=0 means black and L=100 white. The values of a and b indicate the positions of the color on the red/green and yellow/blue color axes respectively, where +a represents red, −a represents green, +b represents yellow and −b represents blue. The HC60 is calculated by the formula HC60=L−3b.

The color measurement corresponds to the three-area method according to DIN 5033-6.

### Aging Test

Measurement 1 (initial color): A plastic dish of internal diameter 9 cm is overfilled with superabsorbent particles which are then smoothed flat with a blade over the edge, and the CIE color numbers and the HC60 value are determined.

Measurement 2 (after aging): A plastic dish of internal diameter 9 cm is filled with superabsorbent particles which are then smoothed flat with a blade over the edge. The dish is then placed open into a climate-controlled cabinet heated to 60° C. with constant relative air humidity of 86%. After 21 days have passed, the dish is taken out. After cooling to room temperature, the CIE color numbers are determined.

### EXAMPLES

The piece of equipment used as the mixer was a Pflugschar® M5 jacketed plowshare mixer from Gebr. Lödige Maschinenbau GmbH, Elsener-Strasse 7-9, 33102 Paderborn, Germany. The piece of equipment used as the kneader was a Pflugschar® 5R-MK jacketed plowshare kneader from the same manufacturer.

Cublen® K 2012 is a 20% by weight aqueous solution of 1-hydroxyethane-1,1-diphosphonic acid, disodium salt. Cublen® K 3014 is a 20% by weight aqueous solution of 1-hydroxyethane-1,1-diphosphonic acid, tetrasodium salt. Cublen® K60 is a 60% by weight aqueous solution of 1-hydroxyethane-1,1-diphosphonic acid. Cublen® K 4023 is a 26% by weight aqueous solution of 1-hydroxyethane-1,1-diphosphonic acid, tripotassium salt. These substances are available from Zschimmer & Schwarz Mohsdorf GmbH & Co KG, Chemnitztalstrasse 1, 09217 Burgstädt, Germany. Laromer® PO 9044V is the triacrylate of triethoxylated glycerol, available from BASF SE, Ludwigshafen, Germany. DAROCUR® 1173 is 2-hydroxy-2-methyl-1-phenylpropan-1-one, available from BASF Switzerland AG, Basle, Switzerland. IRGACURE° 651 is 2,2-dimethoxy-1,2-diphenylethan-1-one, likewise available from BASF Switzerland AG, Basle, Switzerland.

### Example 1

### Production of a Base Polymer

A 21 stainless steel vessel was initially charged with 326.7 g of 50% by weight sodium hydroxide solution and 675 g of frozen deionized water. 392.0 g of acrylic acid were added while stirring, in the course of which the rate of addition was adjusted such that the temperature did not exceed 35° C. The mixture was then cooled with stirring and the aid of a cooling bath. When the temperature of the mixture had declined to 20° C., 0.79 g of Laromer® PO 9044V, 0.041 g of DAROCUR® 1173 and 0.014 g of IRGACURE° 651 were added. Cooling was continued, and on attainment of 15° C. the mixture was freed of oxygen by passing nitrogen through by means of a glass frit. On attainment of 0° C., 0.51 g of sodium persulfate (dissolved in 5 ml of water) and 0.06 g of hydrogen peroxide (dissolved in 6 ml of water) were added, and the monomer solution was transferred into a glass dish. The glass dish had such dimensions as to establish a layer thickness of the monomer solution of 5 cm. Subsequently, 0.39 g of the disodium salt of 2-hydroxy-2-sulfonatoacetic acid, dissolved in 7.5 ml of water, was added and the monomer solution was stirred briefly with the aid of a glass rod. The glass dish containing the monomer solution was placed under a UV lamp (UV intensity=25 mW/cm²), and polymerization set in. After 16 minutes, the resulting gel was ground three times with the aid of a commercial meat grinder with a 6 mm die plate, and dried in a laboratory drying cabinet at 160° C. for one hour. The product was then ground and the sieve fraction of 150-850 μm was obtained. This procedure was repeated several times in order to obtain a sufficient amount of polymer for the further steps. The base polymer thus prepared had the properties shown in table 1.

### Surface Postcrosslinking

For surface postcrosslinking, 1.2 kg of the base polymer were coated in the mixer, at room temperature and a shaft speed of 450 revolutions per minute, by means of a two-phase spray nozzle, with a mixture of 0.84 g of N-(2-hydroxyethyl)-2-oxazolidinone, 10.8 g of 1,2-propanediol and 25.2 g of water. After the spray application, the product temperature was increased to 185° C. and the reaction mixture was held at this temperature and a shaft speed of 80 revolutions per minute for 60 minutes. The resulting product was allowed to cool to room temperature again and sieved. The surface postcrosslinked superabsorbent was obtained as the sieve fraction having particle sizes between 150 μm and 850 μm, and had the properties shown in table 1.

### Aftertreatment

1.0 kg of the surface postcrosslinked polymer were coated in the mixer, at 70° C. and a shaft speed of 250 revolutions per minute, by means of a two-phase spray nozzle, with 12.5 g of Cublen® K 2012. The spray application was followed by continued mixing of the reaction mixture at a shaft speed of 80 revolutions per minute for 15 minutes. The resulting product was allowed to cool to room temperature and freed of agglomerates by means of a sieve with mesh size 850 μm. The proportion of agglomerates >850 μm thus removed was 14.4 g. The product thus aftertreated had the properties shown in table 1.

### Example 2 (Comparative)

Example 1 was repeated, except that 3.9 g of an aqueous, 10% by weight solution of sodium hydrogensulfite were added rather than the 0.39 g of the disodium salt of 2-hydroxy-2-sulfonatoacetic acid, dissolved in 7.5 ml of water. The proportion of agglomerates subsequently removed was 15.2 g. Base polymer, surface postcrosslinked polymer and aftertreated polymer had the properties specified in table 1.

### Example 3 (Comparative)

Example 1 was repeated, except that 3.9 g of an aqueous, 10% by weight solution of sodium thiosulfate were added rather than the 0.39 g of the disodium salt of 2-hydroxy-2-sulfonatoacetic acid, dissolved in 7.5 ml of water. The proportion of agglomerates subsequently removed was 15.0 g. Base polymer, surface postcrosslinked polymer and aftertreated polymer had the properties specified in table 1.

### Example 4 (Comparative)

Example 1 was repeated, except that 0.047 g of ascorbic acid, dissolved in 7.5 ml of water, were added rather than the 0.39 g of the disodium salt of 2-hydroxy-2-sulfonatoacetic acid, dissolved in 7.5 ml of water. The proportion of agglomerates subsequently removed was 14.0 g. Base polymer, surface postcrosslinked polymer and aftertreated polymer had the properties specified in table 1.

### Example 5 (Comparative)

An attempt was made to repeat example 1, except that 19.6 g of Cublen® K 2012 were added rather than the 0.39 g of the disodium salt of 2-hydroxy-2-sulfonatoacetic acid, dissolved in 7.5 ml of water. The polymerization set in very reluctantly. After 16 minutes, the material in the glass dish was still a viscous sludge which could not be worked up any further.

### Example 6 (Comparative)

Example 4 was repeated, except that a mixture of 12.5 g of Cublen® K 2012 and 1 g of the disodium salt of 2-hydroxy-2-sulfonatoacetic acid, dissolved in 19 ml of water, was used for aftertreatment. The proportion of agglomerates subsequently removed was 56.8 g. Base polymer, surface postcrosslinked polymer and aftertreated polymer had the properties specified in table 1.

### Example 7 (Comparative)

Example 1 was repeated, except that, first of all, the meat grinder was used only once rather than three times, and then the gel which had been ground once was admixed with a mixture of 2.5 g of Cublen K 2012 and 20 ml of water and then ground twice more. In addition, no aftertreatment was conducted after the surface postcrosslinking. Base polymer and surface postcrosslinked polymer had the properties specified in table 1.

### Example 8

Example 4 was repeated, except that, first of all, the meat grinder was used only once rather than three times, and then the gel which had been ground once was admixed with 0.39 g of the disodium salt of 2-hydroxy-2-sulfonatoacetic acid, dissolved in 20 ml of water, and then ground twice more. The proportion of agglomerates subsequently removed was 13.6 g. Base polymer and surface postcrosslinked polymer had the properties specified in table 1.

### Example 9 (Comparative)

Example 4 was repeated, except that, first of all, the meat grinder was used only once rather than three times, and then the gel which had been ground once was admixed with 19.5 g of an aqueous, 2% by weight solution of potassium hydrogensulfite and then ground twice more. The proportion of agglomerates subsequently removed was 15.2 g. Base polymer and surface postcrosslinked polymer had the properties specified in table 1.

### Example 10

14.3 kg of aqueous sodium acrylate solution (37.5% by weight solution in deionized water), 1.4 kg of acrylic acid and 350 g of deionized water were mixed with 12.5 g of Laromer® PO 9044V. This solution was dropletized in a heated, nitrogen-filled dropletization tower (180° C., height 12 m, diameter 2 m, gas velocity 0.1 m/s in cocurrent, dropletizer with diameter 40 mm, internal height 2 mm and a dropletizer plate with 60 holes each of diameter 200 μm) at a rate of 32 kg/h; its temperature was 15° C. Just upstream of the dropletizer, the monomer solution was mixed with three initiator solutions using a static mixer. Initiator 1 was an aqueous solution comprising 5% by weight of the disodium salt of 2-hydroxy-2-sulfonatoacetic acid, initiator 2 a 10% by weight solution of sodium peroxodisulfate in deionized water, and initiator 3 an aqueous solution comprising 2.5% by weight of 2,2′-azobis[2-(2-imidazolin-2-yl)propane]dihydrochloride. The metering rate of initiator solution 1 was 0.33 kg/h, the metering rate of initiator solution 2 was 0.27 kg/h and the metering rate of initiator solution 3 was 0.22 kg/h. The superabsorbent was obtained as the sieve fraction with particle sizes between 150 μm and 850 μm. No separate surface postcrosslinking operation was conducted. It had the properties specified in table 1.

1.2 kg of the surface postcrosslinked polymer were admixed in the mixer at room temperature and a shaft speed of 80 revolutions per minute with 1.8 g of a hydrophobic precipitated silica (Sipernat® D-17, Evonik Degussa GmbH; Frankfurt am Main, Germany). After a mixing time of 5 minutes, the shaft speed was increased to 250 revolutions per minute and the superabsorbent was coated by means of a two-phase nozzle with 21 g of Cublen® K 3014. The spray application was followed by continued mixing of the reaction mixture at a shaft speed of 80 revolutions per minute for 15 minutes. The resulting product was freed of agglomerates by means of a sieve with mesh size 600 μm. The proportion of agglomerates >600 μm thus removed was 5.3 g. The product thus obtained had the properties specified in table 1.

### Example 11

### Production of a Base Polymer

The kneader was initially charged with 459 g of water, 213.9 g of acrylic acid, 1924.9 g of a 37.3% by weight sodium acrylate solution (100 mol % neutralized) and 2.75 g of Laromer® PO 9044V, and inertized by bubbling nitrogen through for 20 minutes. The reaction mixture was cooled externally such that the subsequent addition of initiator was effected at approx. 20° C. Finally, 0.67 g of sodium persulfate (dissolved in 10 g of water), 0.05 g of 30% by weight hydrogen peroxide (dissolved in 5 g of water), 0.57 g of the disodium salt of 2-hydroxy-2-sulfonatoacetic acid (dissolved in 12 ml of water) and 0.01 g of ascorbic acid (dissolved in 10 g of water) were added in rapid succession. The reaction set in rapidly and, on attainment of an internal temperature of 30° C., the jacket of the kneader was heated with heat carrier medium at 80° C. in order to conduct the reaction to the end as adiabatically as possible. On attainment of the maximum temperature, the gel formed was cooled down to below 50° C. by means of cooling liquid (−12° C.) and then discharged. The gel was then dried in a laboratory drying cabinet at 160° C. for one hour, then ground, and the sieve fraction of 150-710 μm was obtained. This procedure was repeated several times in order to obtain a sufficient amount of polymer for the further steps. The base polymer thus prepared had the properties shown in table 1.

### Surface Postcrosslinking

The surface postcrosslinking was effected as in example 1, except that, rather than the mixture of 0.84 g of N-(2-hydroxyethyl)-2-oxazolidinone, 10.8 g of 1,2-propanediol and 25.2 g of water, a mixture of 0.84 g of N-(2-hydroxyethyl)-2-oxazolidinone, 4.8 g of 1,2-propanediol, 12.0 g of 2-propanol, 4.8 g of water and 27.3 g of a 22% by weight aqueous aluminum lactate solution were used and, after the spray application, the temperature was increased to 189° C. rather than to 185° C. In addition, rather than the sieve fraction of 150-850 μm, the sieve fraction of 150-710 μm was obtained. The surface postcrosslinked superabsorbent thus produced had an SFC of 125·10⁻⁷ cm³s/g and, in addition, the properties specified in table 1.

### Aftertreatment

The aftertreatment was effected as in example 1, except that, rather than with 12.5 g of Cublen® K 2012, coating was effected with a mixture of 1.67 g of Cublen® K 60 and 20 g of water, and agglomerates were removed by means of a sieve of mesh size 710 μm rather than by means of a sieve of mesh size 850 μm. The proportion of agglomerates subsequently removed was 9.3 g. The polymer thus obtained had an SFC of 108·10⁻⁷ cm³s/g and, in addition, the properties specified in table 1.

### Example 12

Example 11 was repeated, except that, in the preparation of the base polymer, rather than 2.75 g of Laromer® PO 9044V, only 2.14 g were used. In addition, rather than the sieve fraction of 150-710 μm, the sieve fraction of 150-850 μm was obtained therein. In the surface postcrosslinking, rather than the mixture of 0.84 g of N-(2-hydroxyethyl)-2-oxazolidinone, 4.8 g of 1,2-propanediol, 12.0 g of 2-propanol, 4.8 g of water and 27.3 g of a 22% by weight aqueous aluminum lactate solution, a mixture of 0.84 g of N-(2-hydroxyethyl)-2-oxazolidinone, 10.8 g of 1,2-propanediol and 45.6 g of a 20% by weight aqueous aluminum dihydroxymonoacetate solution (Lohtragon® ALA 200 from Dr. Paul Lohmann GmbH KG, 31857 Emmerthal, Germany) was used and, after the spray application, the temperature was increased to 185° C. rather than to 189° C. In addition, rather than the sieve fraction of 150-710 μm, the sieve fraction of 150-850 μm was obtained. The surface postcrosslinked superabsorbent thus produced had a GBP of 56 darcies and, in addition, the properties specified in table 1. In the aftertreatment, rather than the mixture of 1.67 g of Cublen® K 60 and 20 g of water, 15.4 g of Cublen® K 4023 were applied, and agglomerates were removed by means of a sieve of mesh size 850 μm rather than by means of a sieve of mesh size 710 μm. The proportion of agglomerates subsequently removed was 16.9 g. The polymer thus produced had a GBP of 48 darcies and, in addition, the properties specified in table 1.

For all superabsorbents obtained as the end product according to each of examples 1-12, the color numbers were also determined after aging. The results are compiled in table 2. The examples and tables 1 and 2 show that the inventive superabsorbents not only have advantageous initial color numbers (all L values of the initial color in table 1 are above 90 and the high HC60 values show that the inventive superabsorbents are especially less yellowish) but are also much lighter (L values above 80) and less discolored (HC60 values above 50) after aging than comparable products.

TABLE 1
Properties of the polymers prior to aging test

| | Base polymer | | After surface postcrosslinking | | | | | | After aftertreatment | | | | | |
|---|---|---|---|---|---|---|---|---|---|---|---|---|---|---|
| | CRC | Extractables | CRC | AUL | Initial color | | | | CRC | AUL | Initial color | | | |
| Ex. | [g/g] | [% by wt.] | [g/g] | [g/g] | L | a | b | HC60 | [g/g] | [g/g] | L | a | b | HC60 |
| 1 | 40.5 | 15.2 | 33.5 | 23.8 | 91.4 | −0.2 | 7.4 | 69.2 | 33.2 | 23.5 | 91.3 | −0.2 | 7.3 | 69.4 |
| 2*⁾ | 47.6 | 28.9 | 34.4 | 20.6 | 89.6 | −0.9 | 8.1 | 65.3 | 34.0 | 20.2 | 89.4 | −1.0 | 8.2 | 64.8 |
| 3*⁾ | 46.5 | 24.8 | 34.2 | 21.5 | 89.3 | −0.8 | 8.0 | 65.3 | 33.8 | 21.2 | 89.4 | −0.8 | 8.1 | 65.1 |
| 4*⁾ | 39.8 | 13.2 | 33.0 | 24.2 | 88.9 | 0.4 | 8.7 | 62.8 | 32.7 | 23.9 | 88.8 | 0.5 | 8.8 | 62.4 |
| 5*⁾ | — | — | — | — | — | — | — | — | — | — | — | — | — | — |
| 6*⁾ | 39.8 | 13.2 | 33.0 | 24.2 | 88.9 | 0.4 | 8.7 | 62.8 | 32.4 | 23.3 | 88.7 | 0.5 | 8.9 | 62.0 |
| 7*⁾ | 42.5 | 18.4 | 33.8 | 23.0 | 91.0 | 0.2 | 7.9 | 67.3 | — | — | — | — | — | — |
| 8 | 42.3 | 16.8 | 33.6 | 23.4 | 91.3 | −0.1 | 7.6 | 68.5 | 33.3 | 23.1 | 91.3 | −0.2 | 7.5 | 68.8 |
| 9*⁾ | 44.0 | 17.2 | 33.9 | 22.3 | 88.9 | −0.5 | 8.1 | 64.6 | 33.4 | 21.9 | 89.0 | −0.6 | 8.2 | 64.4 |
| 10**⁾ | — | — | 34.1 | 23.2 | 94.3 | 0.4 | 3.1 | 85.0 | 33.6 | 22.0 | 94.4 | 0.5 | 3.3 | 84.5 |
| 11 | 36.2 | 11.8 | 28.4 | 23.5 | 93.6 | −0.6 | 4.6 | 79.8 | 28.1 | 23.2 | 93.5 | −0.7 | 4.8 | 79.1 |
| 12 | 39.2 | 13.9 | 34.2 | 22.4 | 93.8 | −0.8 | 4.4 | 80.6 | 33.8 | 22.0 | 93.9 | −0.7 | 4.5 | 80.4 |

*⁾comparative
**⁾polymer from the dropletization polymerization which has not been separately surface postcrosslinked

TABLE 2
Color numbers of the polymers ultimately
obtained in each case after aging test

After aging test

| Ex. | L | a | b | HC60 |
|---|---|---|---|---|
| 1 | 82.2 | 1.1 | 10.2 | 51.6 |
| 2*) | 73.1 | 3.5 | 12.8 | 34.7 |
| 3*) | 72.6 | 3.8 | 13.2 | 33.0 |
| 4*) | 72.0 | 4.2 | 14.8 | 27.6 |
| 5*) | | | | |
| 6*) | 80.6 | 1.3 | 10.9 | 47.9 |
| 7*) | 74.8 | 1.6 | 12.5 | 37.3 |
| 8 | 81.9 | 1.4 | 10.6 | 50.1 |
| 9*) | 73.0 | 3.6 | 13.0 | 34.0 |
| 10 | 83.4 | 1.5 | 10.4 | 52.2 |
| 11 | 85.7 | 0.9 | 7.1 | 64.4 |
| 12 | 86.2 | 1.0 | 6.8 | 65.8 |

*)comparative

1. A process for producing superabsorbents by polymerizing a monomer solution comprising
a) at least one ethylenically unsaturated monomer which bears an acid group and is optionally present at least partly in salt form,
b) at least one crosslinker,
c) at least one initiator,
d) optionally one or more ethylenically unsaturated monomer copolymerizable with the monomer mentioned under a),
e) optionally one or more water-soluble polymer,
the process further comprising drying the resulting polymer and optionally grinding the dried polymer and sieving the ground polymer and optionally surface postcrosslinking the dried and optionally ground and sieved polymer, wherein at least one sulfonic acid derivative is added to the monomer mixture and/or to the polymer prior to the drying, and at least one phosphonic acid derivative is added to the polymer after the drying or optionally after the surface postcrosslinking.

2. The process according to claim 1, wherein the sulfonic acid derivative added is 2-hydroxy-2-sulfonatoacetic acid and/or a salt thereof.

3. The process according to claim 2, wherein the disodium salt of 2-hydroxy-2-sulfonatoacetic acid is added.

4. The process according to claim 1, wherein the phosphonic acid derivative is selected from the group consisting of (1-hydroxyethane-1,1-diyl)bisphosphonic acid, ethylenediaminetetra(methylenephosphonic acid), diethylenetriaminepenta(methylenephosphonic acid) and [nitrilotris(methylene)]tris(phosphonic acid), and salts thereof is added.

5. The process according to claim 4, wherein the phosphonic acid derivative added is a sodium and/or potassium salt of (1-hydroxyethane-1,1-diyl)bisphosphonic acid.

6. The process according to claim 1, wherein a surface postcrosslinking is conducted.

7. The process according to claim 1, wherein monomer a) is acrylic acid present at least partly in the form of sodium acrylate.

8. A superabsorbent obtainable by the process described in claim 1.

9. An article for absorption of fluids, comprising the superabsorbent of claim 8.

10. A process for producing articles for absorption of fluid, wherein the production of the articles involves addition of a superabsorbent of claim 8.
